(19) United States
(12) Patent Application Publication
(10) Pub. No.: US 2005/0273181 A1
(43) Pub. Date: Dec. 8, 2005

(54) Remote control apparatus and remote control system for electronic device

(75) Inventors: Jun Peng, Tokorozawa-shi (JP); Mikiko Hirata, Tokorozawa-shi (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION

(21) Appl. No.: 11/084,188

(22) Filed: Mar. 21, 2005

(30) Foreign Application Priority Data
Mar. 19, 2004 (JP) P2004-81409

(51) Int. Cl. G05B 11/01

(52) U.S. Cl. 700/14; 700/83; 340/825.72; 345/156

(57) ABSTRACT

A remote control device which remotely controls an electronic apparatus including: a recording device which records control information that defines each of operations of processes in the electronic apparatus; a control device which displays an operation screen on which a plurality of selection images for a selection of each of the processes that are defined by the control information are arranged; an instruction input device which includes at least an operating element that is located on a surface of the display device and has an operation area which accepts an input operation according to the selection images selected by a user; and a sending device which sends at least a part of the control information in correspondence with the input operation by the user on the instruction input device, wherein the control device changes the operation screen which is to be displayed on the display device in response to the input operation by the user and simultaneously the operation area in the operating element in response to the change of the operation screen.

### BACKGROUND OF THE INVENTION

1. Field of the Invention

The present invention relates to a technical field for remote-controlling an electronic device as an object of the control.

2. Related Art

In a conventional electronic apparatus control device for remote-controlling the electronic apparatus is included as an accessory, and the included remote control device is used to remote-control the electronic apparatus.

Further, it is disclosed in for example the US Unexamined Patent Publication No. US2002-18094A1 that remote control information corresponding to a plurality of device types is recorded in advance and at a time of manufacturing the remote control device so as to be able to control a plurality of device types by one remote controller, and new remote control information of a new-type electronic device which is developed after manufacturing the remote control device is subsequently recorded. The US Unexamined Patent Publication No. US2002-180894A1 is incorporated by reference.

Meanwhile, a user of an electronic apparatus may actually be not only an adult but also a child, and there maybe a user having a different dominant hand. Accordingly, usable shapes of remote control device differ user by user. For example, any one of a dextrality user and a sinistrality user may feel inconvenience without horizontally flipping arranged buttons. Accordingly, it is preferable to provide a remote control device having a different shape in conformity with a preference of user in consideration of user friendliness.

However, it is unrealistic to change the shapes of remote control device which is included in electronic apparatuses in conformity with the preferences of users in terms of increment of production cost. Further, although it is possible to realize monogenesis of the remote control devices in accordance with the remote control device described in the above patent publication, it is impossible to change the shape of the remote control device in conformity with preferences of users.

Especially, in these days when the electronic apparatuses are highly functionalized and the remote control device is complicated, it is anticipated that the shape of remote control device causes to affect the conveniences of the users.

### SUMMARY OF THE INVENTION

The present invention is provided in view of the above problems and to provide, as one of the objects, a remote control apparatus and a remote control system which can suppress an increment of a manufacturing cost of the remote control apparatus and improve convenience for a user.

The present invention is provided to solve the above problems.

According to a first aspect of the present invention, there is provided a remote control device which remotely controls an electronic apparatus comprising:

a recording device which records control information that defines each of operations of processes in the electronic apparatus;

a control device which displays an operation screen on which a plurality of selection images for a selection of each of the processes that are defined by the control information are arranged;

an instruction input device which includes at least an operating element that is located on a surface of the display device and has an operation area which accepts an input operation according to the selection images selected by a user; and

a sending device which sends at least a part of the control information in correspondence with the input operation by the user on the instruction input device, wherein

the control device changes the operation screen which is to be displayed on the display device in response to the input operation by the user and simultaneously the operation area in the operating element in response to the change of the operation screen.

According to a second aspect of the present invention, there is provided a remote control device according to the above aspect, wherein

the recording device records the control information including at least a control code which corresponds to an executive instruction of each of the processes in the electronic apparatus, display data which correspond to the selection images, arrangement data which designate arrangement positions of the selection images in the operation screen, and

the control device makes the operation screen display on the display device on the basis of the display data and the arrangement data.

According to a third aspect of the present invention, there is provided a remote control device according to the above aspect, wherein

the instruction input device has a second operating element which directs a change of the arrangement position of the selection image on the operation screen, and

the control device generates second arrangement data which designates the arrangement position after the change when an input operation for changing the arrangement position of the selection image is done, and displays the operation screen on the basis of the second arrangement data and the display data.

According to a fourth aspect of the present invention, there is provided a remote control device according to the above aspect, wherein the control device rewrites the arrangement data which are included in the control information by the generated second arrangement data, and displays the operation screen on the basis of the second arrangement data and the display data.

According to a fifth aspect of the present invention, there is provided a remote control device according to the above aspect, wherein the control device displays the operation screen on the basis of the display data which are included in the generated second arrangement data and the display data included in the control information without adding a change to the control information itself.

According to a sixth aspect of the present invention, there is provided a remote control device according to the above aspect, further comprising:

an arrangement data sending device which sends the generated second arrangement data to the electronic apparatus.

According to a seventh aspect of the present invention, there is provided a remote control device according to the above aspect, wherein the remote control device generates second arrangement data by which at least the arrangement position of the selection image is horizontally flipped on the operation screen when an input operation is done to change the arrangement position of the selection image, and displays the operation screen on the display device on the basis of the second arrangement data thus generated and the display data.

According to an eighth aspect of the present invention, there is provided a remote control device according to the above aspect, wherein the remote control device generates second arrangement data by which at least the arrangement position of the selection image is vertically flipped on the operation screen when an input operation is done to change the arrangement position of the selection image, and displays the operation screen on the display device on the basis of the second arrangement data thus generated and the display data.

According to a ninth aspect of the present invention, there is provided a remote control device according to the above aspect, wherein the remote control device generates second arrangement data by which at least a gap between the selection images is changed on the operation screen when an input operation is done to change the arrangement position of the selection image, and displays the operation screen on the display device on the basis of the second arrangement data thus generated and the display data.

According to a tenth aspect of the present invention, there is provided a remote control device according to the above aspect, wherein the remote control device generates second arrangement data by which at least the arrangement position of the selection images which is designated by a user is changed to the position designated by the user when an input operation is done to change the arrangement position of the selection image, and displays the operation screen on the display device on the basis of the second arrangement data thus generated and the display data.

According to an eleventh aspect of the present invention, there is provided a remote control device according to the above aspect, wherein

the instruction input device has a third operating element which directs a change of the number of the arrangement of the selection images on the operation screen, and

the control device generates third arrangement data which designate the number of the arrangement of the selection images after the change when an input operation for changing the number of the arrangement of the selection images is done, and displays the operation screen on the basis of both of the third arrangement data and the display data.

According to a twelfth aspect of the present invention, there is provided a remote control system comprising:

an electronic apparatus; and

a remote control device which remotely controls the electronic apparatus wherein,

the remote control device includes:

a recording device which records control information that defines each of operations of processes in the electronic apparatus;

a control device which displays an operation screen on which a plurality of selection images for a selection of each of the processes that are defined by the control information are arranged;

an instruction input device which includes at least an operating element that is located on a surface of the display device and has an operation area which accepts an input operation according to the selection images selected by a user; and

a sending device which sends at least a part of the control information in correspondence with the input operation by the user on the instruction input device, wherein

the control device changes the operation screen which is to be displayed on the display device in response to the input operation by the user and simultaneously the operation area in the operating element in response to the change of the operation screen, and

the electronic apparatus has a control device which conducts a process corresponding to the control information which is sent by the sending device of the remote control device.

According to a thirteenth aspect of the present invention, there is provided a remote control system according to the above aspect, wherein

the recording device of the remote control device records the control information including at least a control code which corresponds to an executive instruction of each of the processes in the electronic apparatus, display data which correspond to the selection images, arrangement data which designate arrangement positions of the selection images in the operation screen, and

the control device of the remote control device makes the operation screen display on the display device on the basis of the display data and the arrangement data.

According to fourteenth aspect of the present invention, there is provided a remote control system according to the above aspect, wherein

the instruction input device of the remote control device has a second operating element which directs a change of the arrangement position of the selection image on the operation screen, and

the control device of the remote control device generates second arrangement data which designates the arrangement position after the change when an input operation for changing the arrangement position of the selection image is done, and displays the operation screen on the basis of the second arrangement data and the display data.

According to fifteenth aspect of the present invention, there is provided a remote control system according to the above aspect, wherein

the remote control device further includes an arrangement data sending device which sends the second arrangement data thus generated, and

the electronic apparatus further includes:

an arrangement data recording device which records the second arrangement data thus sent;

a distribution device which distributes the second arrangement data thus recorded in response to a request from the remote control device.

### BRIEF DESCRIPTION OF THE DRAWINGS

In the accompanying drawings:

FIG. 1 is a block chart for showing a structure of a remote control system S of an electronic apparatus according to Embodiment 1;

FIG. 2 is a block chart for showing a structure of an electronic apparatus 1-k according to the same embodiment as a DVD recorder;

FIG. 3 is a block chart for showing a structure of an electronic apparatus 1-k according to Embodiment 1 as an electric power amplifier according to the same embodiment;

FIG. 4 is a diagram for showing an example of a format of a remote control information recorded in the remote control information recording unit 125 according to the same embodiment;

FIG. 5 is a block chart for showing an internal structure of the remote control apparatus 2 according to the the same embodiment;

FIG. 6 is a block chart for showing an external structure of the remote control apparatus 2 according to the the same embodiment;

FIG. 7 is an example of conversion diagram file which is acquired by the remote control apparatus 2 according to the same embodiment;

FIG. 8 is an example of arrangement diagram file according to the same embodiment;

FIG. 9 is a diagram for showing a process which is executed in a remote control system S according to this embodiment;

FIG. 10 is a flow chart for showing a process which is conducted by a control unit 21 of a remote control device 2;

FIG. 11 is an example of an image displayed in a display portion 27 of a remote control apparatus 2 according to this embodiment;

FIG. 12 is a flow chart for showing a content of a process conducted by a remote control unit 123 of an electronic apparatus 1-k according to this embodiment;

FIG. 13 is an example of an image which is displayed on a display portion 27 of the remote control device 2 according to this embodiment;

FIG. 14 is a flow chart for showing a process which is conducted by a control unit 21 of a remote control unit 2 at a time of generating an arranged table file according to this embodiment;

FIG. 15 is a flowchart for showing a process which is conducted by the control unit 21 of the remote control unit 2 at the time of generating the arranged table file according to this embodiment;

FIG. 16 is a flowchart for showing a process which is conducted by the control unit 21 of the remote control unit 2 at the time of generating the arranged table file according to this embodiment;

FIG. 17 shows an example of an arranged table file according to modified example 3;

FIG. 18 is a flowchart for showing a process which is conducted by a control unit 21 of a remote control device 2 at a time of generating an arranged table file according to this modification example;

FIG. 19 shows an example of a recorded content of a drawing code recording unit 23 of a remote control unit 2 according to Embodiment 2;

FIG. 20 is a flowchart for showing a process which is conducted by a control unit 21 of a remote control device 2 according to the same embodiment; and

FIG. 21 is a flowchart for showing a process which is conducted by a control unit 21 of a remote control device 2 according to the same embodiment.

### DESCRIPTION OF THE PREFERRED EMBODIMENTS

Preferred embodiments of the present invention will be described in conjunction with the figures.

Hereinafter, each meaning of the reference numbers in the figures is as follows:
S: REMOTE CONTROL SYSTEM
1-k (k=1, 2, . . . , m): ELECTRONIC APPARATUS
11a,11b: ORIGINAL OPERATION UNIT
12: REMOTE CONTROL OPERATION UNIT
121: RECEIVING UNIT
122: SENDING UNIT
123: REMOTE CONTROL UNIT
124: DRAWING CODE RECORDING UNIT
125: REMOTE CONTROL INFORMATION RECORDING UNIT
2: REMOTE CONTROL DEVICE
21: CONTROL UNIT
22: REMOTE CONTROL INFORMATION RECORDING UNIT
23: DRAWING CODE RECORDING UNIT
24: SENDING UNIT
25: RECEIVING UNIT
26: INSTRUCTION INPUT UNIT
27: DISPLAY UNIT

### [1] Embodiment 1

[1.1] Structure of Embodiment 1

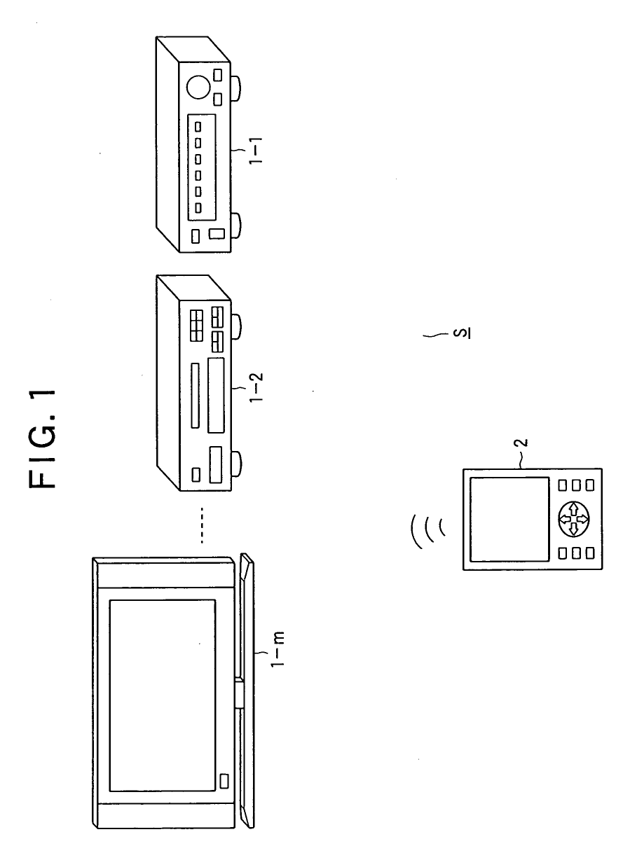

First, an entire structure of a remote control system S of an electronic apparatus according to this embodiment will be described in reference of FIG. 1. As shown in the figure, the remote control system S according to the embodiment includes a plurality of electronic apparatuses 1-k (k=1, 2, . . . , m) and a remote control device 2. In FIG. 1, in order to prevent the figure from being complicated, only a predetermined electronic apparatus 1-k among the plurality of electronic apparatuses 1-k is shown. However, it is arbitrary how many electronic apparatuses 1-k is included in order to form the system S. Further, it is also arbitrary to select which type (i.e. a DVD recorder or a television broadcast receiver) and which model of the electronic apparatus.

The remote control system S is to remote-control a plurality of electronic apparatuses respectively having different operations in use of one remote control device 2. In the remote control system S, when the remote control is done, the remote control device 2 sends an acquisition request of remote control information for remote-controlling the electronic apparatus 1-k to the electronic apparatus 1-k. In response to the acquisition request, the electronic apparatus is remote-controlled while utilizing the remote control information which is sent from the electronic apparatus.

Hereinafter, a structure of the remote control system S having this operation will be specifically described.

First, the electronic apparatus 1-k is for example an electric amplifier such as an audio visual (AV) amplifier, a DVD recorder, a television set, or a video tape recorder. The electronic apparatuses performs various processes based on a control signal sent from the remote control device. For example, in a case where the electronic apparatus 1-k is a DVD recorder, when a control signal sent from a remote control device 2 is received, a process of changing the received channel is conducted in accordance with the received signal.

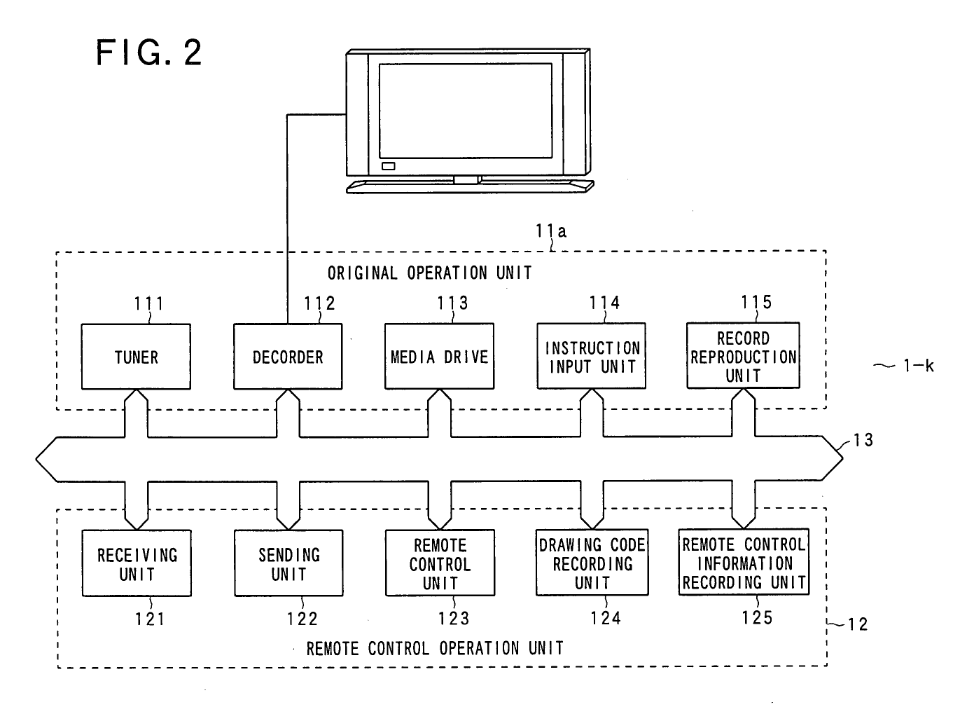

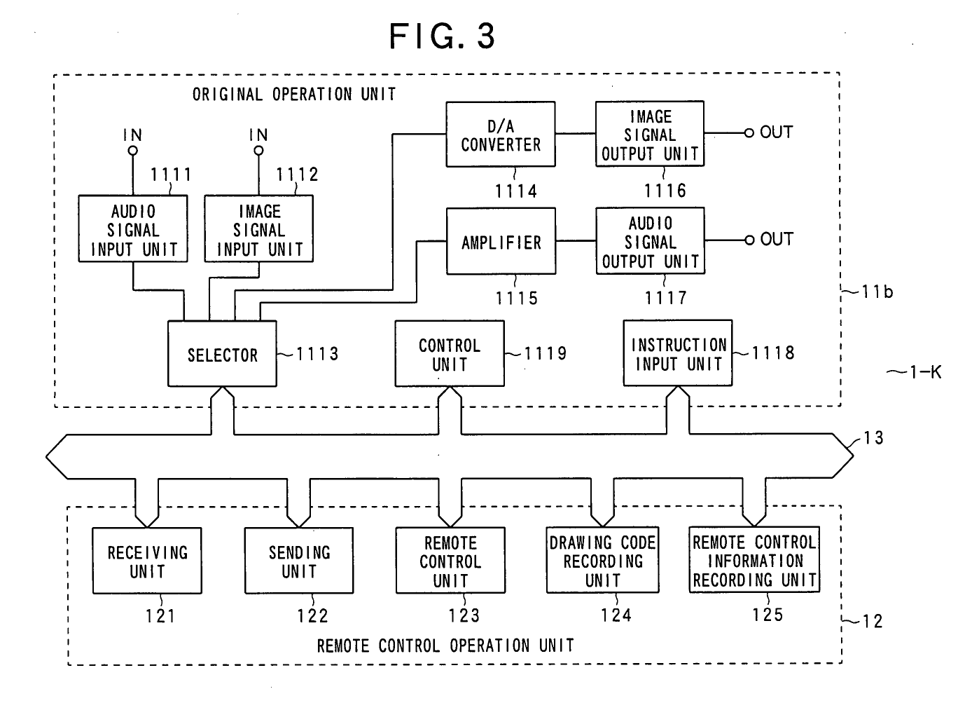

A specific structure of the electronic apparatus 1-k will be described in reference of FIGS. 2 and 3. Meanwhile, because various types and models of the electronic apparatuses 1-k are included in this embodiment, FIG. 2 shows an example of a structure when the electronic apparatus 1-k is a DVD recorder and FIG. 3 shows an example a structure when the electronic apparatus 1-k is an electric power amplifier.

As shown in figures, the electronic apparatus 1-k according to this embodiment is generally made up of original operation units 11a and 11b (hereinafter referred to as original operation unit 11) having different structures with respect to the electronic apparatuses 1-k and a remote control operation unit 12 which is uniquely equipped in each of the electronic apparatuses irrespective of attributes such as types and models of each of the electronic apparatuses. Although the remote control operation units 12 are common in FIGS. 2 and 3, the original operation unit 11a and the original operation unit 11b have completely different structures.

The original operation unit 11 is an element for realizing an operation originally provided in the electronic apparatus 1-k and the structure thereof is the same as that in the conventional electronic apparatus. For example, in case of a DVD recorder, an operation of recording content data in a DVD media which is set in a media drive and an operation of reproducing the content data recorded in a DVD media are the original operation. In order to realize such a operation, in a case shown in FIG. 2, for example, the original operation unit 11a is made up of:
(a) a tuner 111 which demodulates a broadcast wave of for example a digital terrestrial broadcast which is received through an antenna and inputs obtained data into a decoder and a reproduction control unit,
(b) a decoder which demodulates a signal inputted from a media drive or a tuner and output to a monitor,
(c) a media drive 113 which reads out content data that are recorded in an inserted media and input it to a decoder under a control of the record and reproduction unit, and writes data that are received from the tuner to a DVD media,
(d) an instruction input unit 114 which has input buttons of such as reproduction and stop and outputs an input signal corresponding to an input operation by a user, and
(e) a record reproduction unit 115 which controls the tuner and the media drive in response to an input signal from the instruction input unit and a remote control operation unit 12.

On the other hand, when the electronic apparatus 1-k is for example an electric amplifier such as an AV amplifier, an original operation is such that an inputted audio signal is amplified and then outputted from an audio output terminal, and simultaneously one signal out of a plurality of inputted image signals that are inputted to each of the plurality of the image input terminals is selected and outputted to an image output terminal. Accordingly, when the electronic apparatus 1-k is an electric power amplifier, as in an example of FIG. 3, the original operation unit 11b is constituted by for example:
(a) an audio signal input unit 11 which is made up of a plurality of audio signal input terminals and receives audio signals,
(b) an image signal input unit 1112 which is made up of a plurality of image input terminals and receives an image signal,
(c) a selector 1113 which selects input signals from a plurality of audio signals and a plurality of image signals,
(d) a D/A converter 1114 which performs a digital conversion and an analogue conversion to the signal selected by the selector,
(e) an amplifier 1115 which amplifies the audio signal selected by the selector,
(f) an image signal output unit 1116 which outputs the image signal outputted from the D/A converter,
(g) an audio signal output unit 1117 which outputs the audio signal amplified by the amplifier,
(h) an instruction input unit 1118 which has an input button and outputs the input signal corresponding to an input operation by the user, and
(i) a control unit which controls the selector and the amplifier in response to the input signals from the instruction input unit and the remote control operation unit 12.

Next, the remote control operation unit 12 receives the control signal sent from the remote control device 2 to control the original operation unit 11 in accordance with the received control signal. In order to achieve the operation, the remote control operation unit 12 of the electronic apparatus 1-k according to this embodiment has a receiving unit 121, a sending unit 122, a remote control unit 123, a drawing code recording unit 124, and a remote control information recording unit 125.

The receiving unit 121 receives a control signal sent from the remote control device 2 and outputs data included in the received control signal to a data bass 13. The receiving unit 122 sends data which are inputted through the data bass 13 to the remote control device 2. It is arbitrary what communication interface (hereinafter abbreviated by a reference “I/F”) is used to connect the receiving unit 121 to the sending unit 122. For example, it is possible to integrally construct in use of a communication interface which enables a bidirectional communication and separately construct in use of a communication I/F which enables only a one way communication.

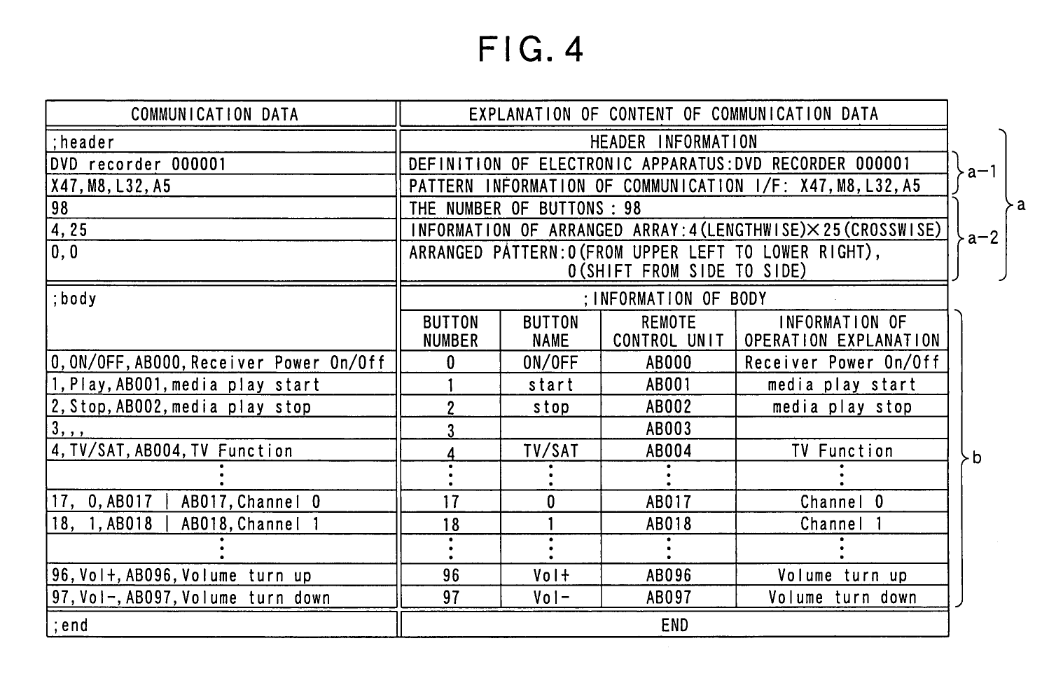

The remote control information recording unit 125 is made up of a nonvolatile memory such as an electrically erasable programmable read only memory (EEPROM) or a recording medium such as a hard disk, wherein the remote control information as shown FIG. 2 is recorded. FIG. 4 shows an example of data format of a remote control information when in a case where the electronic apparatus 1-k is a DVD recorder. As shown in the figure, the remote control information according to the figure generally include header information a and body information b.

The header information a designates a basic structure of the remote control information, and includes attribute information a-1 which describes an attribute such as a type of communication I/F that forms the receiving unit 121 and button information a-2.

The button information a-2 is information which makes an icon (hereinafter referred to as a button) provided for a user's selection of various commands to the electronic apparatus such as reproduction and stop of media. The information includes the followings. Meanwhile, the button corresponds to “selection image” in the claims and an operation image having the buttons arranged therein corresponds to for example “operation screen”.

(a) Information of the Number of Button

The information shows the number of buttons to be displayed on the remote control device 2. The operation image having thus determined number of the buttons arranged therein is displayed in the remote control device 2. For example, in a case of the remote control information shown in FIG. 4, a number “98” is described as information of the button number. Accordingly, on the basis of the remote control information shown in FIG. 4, the buttons as much as 98 are displayed in the remote control device 2.

(b) Information OF Arranged Array

This information is about how many rows and how many columns are used to arrange the buttons.

For in the case of the remote control information shown in FIG. 4, information of “4×25” is described as the information OF arranged array. Therefore, the buttons are displayed in the remote control device 2 horizontally in 4 rows and vertically in 25 columns.

(c) Information of Arranged Pattern

This information is to designate a starting position of the arrangement and an arrangement direction of the buttons in the remote control device 2. The information can be represented by a parameter 1 and a parameter 2. Each meaning of the parameters is as follows:

<Parameter 1>

This parameter 1 designates the starting point of displaying the buttons and the ending point of displaying the buttons. There are four types “0”, “1”, “2”, and “3” in this parameter.

(i) In Case of “0”

From the left end column of the uppermost row on the operation screen, the arrangement of the buttons is started and ends at the right end column of the lowermost row.

(ii) In Case of “1”

From the right end column of the uppermost row on the operation screen, the arrangement of the buttons is started and ends at the left end column of the lowermost row.

(iii) In Case of “2”

From the left end column of the lowermost row on the operation screen, the arrangement of the buttons is started and ends at the right end column of the uppermost row.

(iv) In Case of “3”

From the right end column of the lowermost row on the operation screen, the arrangement of the buttons is started and ends at the left end column of the uppermost row.

<Parameter 2>

This parameter 2 designates the direction of displaying the buttons. There are two types “0” and “1” in this parameter.

(i) In Case of “0”

When the buttons are started to be displayed from the starting point of the buttons, the display positions of the buttons rightward or leftward shift at each increment of a button number, which is described later.

(ii) In Case of “1”

When the buttons are started to be displayed from the starting point of the buttons, the display positions of the buttons downward or upward shift at each increment of a button number, which is described later.

By combining these parameters 1 and 2, the following display is obtained on the remote control device 2.

### EXAMPLE 1

In Case that the Parameter 1 is “0” and the Parameter 2 is “0”

The arrangement of the buttons is started from the left end column of the uppermost row on the operation screen, and the display positions of the buttons are rightward shifted by one column at each increment of the button number, which is described later. When the number of the buttons with respect to the pending row, which number is designated by the information of the arranged array, is satisfied, the display position shifts to the next row. For example, in the case shown in FIG. 4, the button corresponding to the button number of “0” is displayed at the left end column of the uppermost row, and consecutively the button corresponding to the button number of “1” is displayed on the right side of the button corresponding to the button number of “0”. As a result, the buttons corresponding to “0” to “3” are displayed on the first row, and the buttons corresponding to “4” to “7” are displayed on the next row.

### EXAMPLE 2

In Case that the Parameter 1 is “1” and the Parameter 2 is “0”

The arrangement of the buttons is started from the right end column of the uppermost row on the operation screen, and the display positions of the buttons are leftward shifted by one column at each increment of the button number. When the number of the buttons with respect to the pending row, which number is designated by the information of the arranged array, is satisfied, the display position shifts to the next row.

### EXAMPLE 3

In Case that the Parameter 1 is “0” and the Parameter 2 is “1”

The arrangement of the buttons is started from the left end column of the uppermost row on the operation screen, and the display positions of the buttons are downward shifted by one row at each increment of the button number. When the number of the buttons with respect to the pending column, which number is designated by the information of the arranged array, is satisfied, the display position shifts to the rightward column by one column.

### EXAMPLE 4

In Case that the Parameter 1 is “2” and the Parameter 2 is “1”

The arrangement of the buttons is started from the left end column of the lowermost row on the operation screen, and the display positions of the buttons are upward shifted by one row at each increment of the button number. When the number of the buttons with respect to the pending column, which number is designated by the information of the arranged array, is satisfied, the display position shifts to the rightward column by one column.

### EXAMPLE 5

In Case that the Parameter 1 is “3” and the Parameter 2 is “1”

The arrangement of the buttons is started from the right end column of the lowermost row on the operation screen, and the display positions of the buttons are leftward shifted by one column at each increment of the button number. When the number of the buttons with respect to the pending row, which number are designated by the information of the arranged array, is satisfied, the display position shifts to the up ward row by one row.

Next, the body information b is information having an element of a remote control code corresponding to the remote control code. The button number, the button name, and information of operation explanation of the button corresponding to the remote control code are described. The remote control code is a command corresponding to a process which should be done by the electronic apparatus 1-k, namely a code for uniquely specifying various commands such as reproduction, stop, or the like of a media. The codes differ by each type and each model of the electronic apparatus 1-k. For example, in a case shown in FIG. 4, a remote control code “AB001” designates a “play” command, i.e. a command for executing a reproduction process of a media. A remote control code “AB002” designates a “stop” command, i.e. a command for stopping a reproduction process of a media.

When the electronic apparatus 1-k is controlled, the remote control device 2 sends a signal which is obtained by modulating the remote control code corresponding to the command that is selected by the user out of the various information contained in the remote control information by a carrier wave. Therefore, when the control signal is received by the receiving unit 121, the remote control unit 123 controls the original operation unit 11 based on a remote control code which is contained in the received control signal.

Further, the button number is information which makes the remote control codes correspond to the various buttons. For example, in the case shown in FIG. 4, since the button number “1” corresponds to the remote control code “AB001”, when the button “1” is selected in the remote control device 2, the control signal obtained by modulating the code “AB001” is sent by the remote control device 2.

Next, the body information b is information using the remote control code as an element, in which the button numbers of the buttons corresponding to the remote control codes, the button names of the buttons and the information of operation explanation are described. The remote codes are commands corresponding to processes which should be done in the electronic apparatus 1-k, namely, the codes for uniquely specifying various commands such as reproduction and stop to the media, wherein the codes are different depending on the type and the model of the electronic apparatuses. For example, in a case of FIG. 4, the remote control code “AB001” designates a “play” command which executes the reproduction process of the media. The remote control code “AB002” designates a “stop” command which stops the reproduction process of the media.

When the electronic apparatus 1-k is controlled, the remote control device 2 sends a control signal which is obtained by modulating the remote control code corresponding to the command that is selected by the user within various information contained in the remote control information by a carrier wave. When the control signal is received by the receiving unit 121, the remote control unit 123 controls the original operation unit 11 based on the remote control code which is contained in the received remote control code.

The button number is information which makes the remote control codes correspond to the various buttons. For example, in the case shown in FIG. 4, since the button “1” is related to the remote control code “AB001”, when the button “1” is selected in the remote control device 2, the control signal obtained by modulating the code “AB001” is sent from the remote control device 2. For example, the “arranged data” in the claims are correspond to the button numbers and the button information a-2.

Meanwhile, the button name is a content what the remote control code means, namely character information designating the content of the command. In the remote control device 2, the character information is used when the various buttons are displayed in the remote control device 2. For example, in the case shown in FIG. 4, A character string “play” corresponds to the button number “1”. Accordingly, in the remote control device 2 which receives the remote control information shows the character string “play” on the button on No. “1”. The button number corresponds “display button” in the claims.

Meanwhile, the information of operation explanation is character information which explains a content of process executed by the electronic apparatus 1-k when the various remote control modes are sent. The operation explanation information is presented to a user when a concise explanation of the processes which is executed in the electronic apparatus 1-k when the various buttons are selected in the remote control terminal 2. The operation explanation information is used to put a so-called help operation into practice.

Next, the remote control unit 123 is includes for example a central processing unit (CPU), a read only memory (ROM), and a random access memory (ROM), and sends remote control information corresponding to the own to the remote control device 2 in response to an acquisition request which is sent from the remote control device 2.

In this, when a plurality of electronic apparatuses 1-k exist within the range of receiving acquisition requests which are sent by the remote control device 2 and the acquisition requests are sent without designating a destination, there may be a case where the remote control information is not obtainable from the electronic apparatus 1-k from which the remote control information is actually desired to get. Accordingly, in this embodiment, the remote control device 2 adds a drawing code for uniquely recognizing the electronic apparatus 1-k as the destination to the acquisition request and sends thus obtained acquisition request. Although the setting method of the drawing code is arbitrarily selected, in this embodiment, the following explanation is about a case where a user arbitrarily set the setting method.

The remote control unit 123 judges whether or not the acquisition request is directed to its own device on the basis of the drawing code which is added to the acquisition request. Only when it is judged that the acquisition request is directed to the own device, the remote control information which is recoded in the remote control information record unit 125 is sent. In order for enabling such a judgment, the drawing code corresponding to the electronic apparatus 1-k is recorded is in the drawing code recording unit 124 in this embodiment. The remote control unit 123 compares the drawing code thus recorded with the drawing code sent from the remote control device 2. When these drawing codes match, it is judged that the acquisition request is directed to the own device.

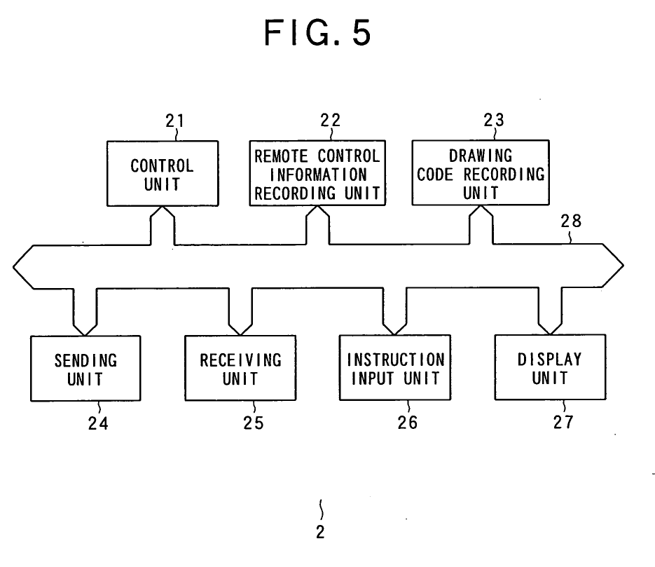

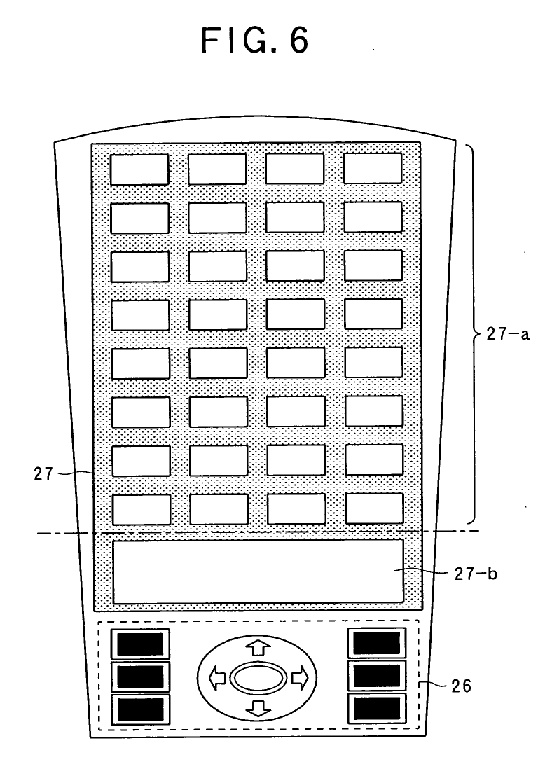

Next, the remote control device 2 is provided to acquire remote control information from the electronic apparatus 1-k and remotely control the electronic apparatus 1-k in use of the remote control information. A block chart for showing the inner structure of the remote control device 2 is in FIG. 5. An example of the outer structure of the remote control device 2 is shown in FIG. 6.

As shown in FIG. 5, the remote control device 2 according to the embodiment includes a control unit 21, a remote control information recording unit 22, a drawing code recording unit 23, a sending unit 24, a receiving unit 25, an instruction input unit 26, a display unit 27, and a data bus 28. For example, “recording unit” in the claims corresponds to the remote control information recording unit 22, and “display unit” in the claims corresponds to the display unit 27. For example, “instruction input unit” in the claims corresponds to the instruction input unit 26, “control device” in the claims corresponds to the control unit 21, and “sending device” in the claims corresponds to the sending unit 24.

The sending unit 24 sends the data which are inputted through the data bus 28 to the electronic apparatus 1-k under a control of the control unit 21. The receiving unit 25 receives the data which are sent by the electronic apparatus 1-k and outputs the received remote control information to the data bus 28. The sending unit 24 and the receiving unit 25 may be realized by any I/F. However, these elements are required to be configured by a communication I/F which can send and receive data to and from the electronic apparatus 1-k.

The display portion 27 is formed by a display device such as a liquid crystal panel and an organic electro luminescent (EL), which are disposed on a front surface of a casing of the remote control device 2 as shown in FIG. 6, and transmits various information to a user by displaying various information. The display unit 27 has a button display area 27-a for displaying an operation screen in which various buttons are arranged in accordance with button information a-2 of remote control information and an auxiliary area 27-b for displaying s character string corresponding to the information of function operation explanation contained in body information b. Methods of displaying various information on the areas 27-a and 27-b will be described in detail below.

The instruction input unit 26 has various buttons and cursor keys, which are arranged on the casing of the remote control device 2 as shown in FIG. 6, and outputs an input signal corresponding to an input operation by a user. Further, the instruction input unit 26 has a touch panel besides the above keys. The touch panel is arranged on the display unit 27. Therefore, the user can do various input operations by contacting and pressing the display unit 27 in accordance with an image which is displayed on the display unit 27.

The remote control information recording unit 22 is made up of a nonvolatile memory such as EEPROM and used as a memory area for recording a remote control information which is obtained from the electronic apparatus 1-k. The drawing code recording unit 23 is formed by a nonvolatile memory in a manner similar to that in the remote control information recording unit 22 and a drawing code which is registered by a user is recorded. Although these remote control information recording unit 22 and drawing code recording unit 23 may be formed by separate memories, it is preferable to form these by one memory in view of reduction of the manufacturing cost. Meanwhile, no information is recorded in the remote control information recording unit 22 at a time of manufacturing the remote control device 2 and the information is first recorded at a time when the remote control information is acquired from the electronic apparatus 1-k.

The control unit 21 has for example a CPU, a ROM, and a RAM and controls various portions of the remote control device 2. Specifically, in this embodiment, the control unit 21 realizes three operations of (a) registering operation of an electronic apparatus to be controlled, (b) a remote control operation of an electronic apparatus, and (c) display mode changing operation. A concrete content of the operations is as follows.

(a) Registering Operation of Electronic Apparatus to be Controlled

This operation is to set a drawing code with respect to various electronic apparatuses and to make the drawing code commonly owned by the remote control device 2 and the electronic apparatus 1-k. Specifically, the drawing code is commonly owned by the remote control device 2 and the electronic apparatus 1-k after conducting the following process in this embodiment.

First when a predetermined input operation is done on the instruction input unit 26, the control unit 21 displays an image for requesting input of the drawing code on the display unit 27, and records the drawing code which is inputted by a user in the drawing code recording unit 23. The control unit 21 sends thus recorded drawing code to the electronic apparatus 1-k. As a result, the drawing code is recorded in the drawing code recording unit 124 of the electronic apparatus 1-k and commonly owned by the device and the apparatus.

On the other hand, it is impossible to select the electronic apparatus 1-k which is to be controlled if a user does not memorize what code is allocated to what electronic apparatus 1-k even though only the drawing code is commonly owned along with the electronic apparatus 1-k. Therefore, when the drawing code is registered, the control unit 21 requests an input of a simple keyword such as “DVD” as a keyword for judging the registered electronic apparatus 1-k, and records the keyword inputted by the user and the drawing code in the drawing code recording unit 23 by correlating these.

(b) Remote Control Operation of Electronic Apparatus

This operation is provided to make a user select an electronic apparatus 1-k which is to be controlled so as to obtain the remote control information corresponding to the selected electronic apparatus 1-k to thereby remotely control the electronic apparatus 1-k. In obtaining the remote control information, the control unit 21 firstly reads out a keyword which is recorded in the drawing code recording unit 23, and makes the button in which the keyword is displayed display on the display unit 27. For example, when keywords of “DVD”, “AMP”, and “TV” are recorded in the drawing code recording unit 23, three buttons with the recorded keywords displayed on these are displayed on the display unit 27.

In this state, when the user does an input operation for selecting the button corresponding to the electronic apparatus 1-k which is to be controlled, the control unit 21 reads out the drawing code which is stored in the drawing code recording unit 23 in correspondence with the keywords corresponding to the selected button. The control unit 21 sends an acquisition request with this drawing code added thereto. As a result, when the remote control information which is sent back from the electronic apparatus 1-k is received by the receiving unit 25, the control unit 21 records the remote control information to the remote control information recording unit.

Thereafter, the control unit 21 displays an operation screen on which the buttons corresponding to various commands are displayed on a button displaying area of the display unit 27. Then the control unit 21 determines a corresponding relationship between an operation area of a touch panel which forms the instruction input unit 26 and various buttons, and transfers to a state of enabling a judgment of what button is selected in response to an input operation by the user via a touch panel.

When the user does the input operation of selecting the button via the touch panel, the control unit 21 extracts the remote control code which is described in the body information b in correspondence with the button number and outputs it to the sending unit 24. As a result, the remote control code is modulated by a carrier wave in the receiving unit 24 and is sent to the electronic apparatus 1-k as a control signal.

Meanwhile, it is arbitrary to determine the number of the electronic apparatuses to be retained as information corresponding to the electronic apparatuses. However, in this embodiment, only remote control information of one unit is retained in view of prevention of increment of the memory capacity of the remote control information recording unit 22, and the recorded remote control information is deleted when the electronic apparatus 1-k to be controlled is switched over.

(c) Display Mode Changing Operation

This operation is to change a display mode of the operation screen with respect to the button display unit 27-a of the display unit 27. The remote control device 2 changes the display mode of the operation screen in use of this operation (c) and also changes an operation area of the touch panel of the instruction input unit 26 so as to correspond to an operation screen after changing the mode. Accordingly, the mode of the remote control device 2 is artificially changed to realize a remote control mode suitable for the user's taste. The change of the display mode of the control screen is realized such that the remote control device 3 generates an arranged table file and the button information a-2 of the remote control information is replaced by the information described in the arranged table file. Meanwhile, the arranged table file corresponds to, for example, “second arrangement data” in the claims.

In the remote control device 2 according to this embodiment, the following change of the display mode is conducted.

(Case 1)

This change mode is to horizontally flip a position of starting the arrangement of the buttons and a direction of arranging the buttons in the operation screen. For example, operationality is improved by horizontally flipping the button arrangement in correspondence with to a dextrality user and a sinistrality user. This change mode is realized in response to such a difference of the dominant hand. As described, although the position of starting the arrangement of the buttons and the direction of the arrangement of the buttons are determined by parameters 1 and 2 corresponding to the arrangement pattern information, the parameter 2 only determines the direction of the display. Therefore, it is possible to horizontally flip the button display position by converting the parameter 1.

(Case 2)

This change mode is to vertically flip the position of starting the arrangement of the buttons and the direction of arranging the buttons. In a similar manner to that in the above “case 1”, this change mode is realized by changing the parameter 1 which corresponds to the arrangement pattern information.

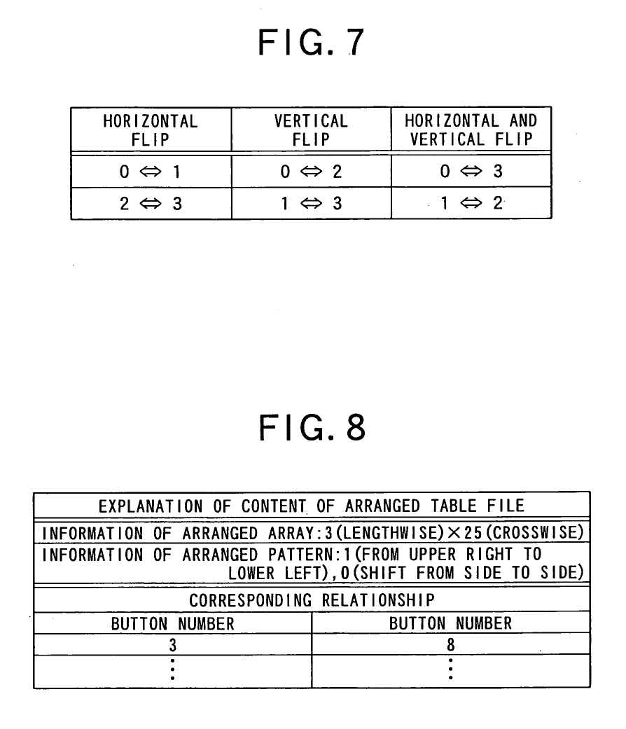

In this, a conversion table of the parameter 1 in cases of the horizontal flip, the vertical flip, and the horizontal and vertical flip is shown in FIG. 7.

In this embodiment, the conversion table is recorded in a ROM (not shown) of the control unit 21. In the case shown in FIG. 4, when the input operation of horizontally reversing with respect to the instruction input unit 26 is conducted, the control unit 21 reads out the parameter 1=“0” which is contained in the remote control information. Then, “1” which corresponds to the parameter 1=“0” is readout of the conversion table concerning the horizontal flip. An arranged table file in which the parameter “1” is described is generated. The case where the vertical reverse is instructed and the case where the horizontal and vertical reverse is instructed are processed in a similar manner thereto.

(Case 3)

This change mode is to change the arrangement density of the buttons such that how many rows and how many columns of the buttons are arranged. For example, since the girths of fingers of a child user and a grown-up user are different, if the buttons are displayed in a single density of display, the operationality is not assured.

(Case 4)

This change mode is to change the position of arranging the buttons on the remote control device 2. There may be a case where a user requires to put the buttons at positions where the user himself can easily push the buttons. This change mod is realized to deal with such a difference of preference. Specifically, the change mode is realized by changing the button number of the body information.

An example of the arrangement table file in a case where the changes corresponding to the above “case 1” to “case 4” are provided is shown in FIG. 8. As shown in the figure, in the arrangement table file according to this embodiment, a parameter 1 for replacement with respect to the remote control information and the arrangement array information for replacement are described.

In the arrangement table file, a relationship of the button numbers is described in response to the display mode of “case 4”. This relationship represents the button number of the button to which the change of the position of the button is indicated and the button number of the button which exists at the position to be replaced. For example, in the case shown in FIG. 8, it is shown that the button no. “8” is to be arranged at the position where the button no. “3” should be arranged.

A button other than the buttons in which the relationship are shown is displayed while sequentially shifting its arrangement position. For example, in a case shown in FIG. 8, after the button no. “8” is arranged at the position where the button no. “3” should be originally arranged, the buttons are sequentially displayed such that the button corresponding to the number of “3” is arranged at the arrangement position of the number of “4”, and the button corresponding to the number of “4” is arranged at the arrangement position of the number of “5”

On the basis of the above arrangement table file, the display mode of the operation screen is changed in the remote control device 2. When the display mode of the operation screen of the remote control device 2 is changed and an operation area on the touch panel of the remote control device 2 is changed on the basis of the above arrangement table file, the user can conduct an input operation of selecting the buttons corresponding to the commands which corresponds to the processes that should be executed by the electronic apparatus 1-k. When the user conducts an input operation for selecting a button, the control unit 21 extracts a remote control code which is described in the body information b in correspondence with the button number corresponding to the selected button and sends it as a control signal. This is similar to the case where the arrangement is not changed.

[1.2] Operation of Embodiment 1

(1) Registering Process of Electronic Apparatus to be Controlled

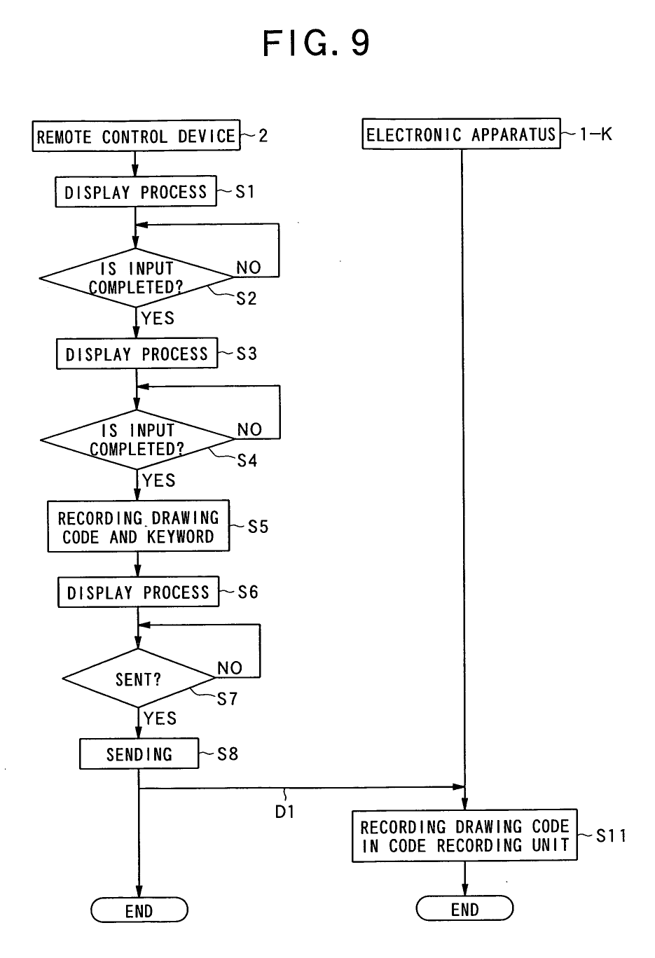

Next, an operation of registering a drawing code in the remote control system S according to this embodiment will be described in reference of FIG. 9. FIG. 9 shows a process which is conducted in the remote control system S according to this embodiment. FIG. 9 shows a process which is conducted by the remote control system S according to this embodiment.

First, a user who has purchased the remote control device 2 throws a power into an electronic apparatus 1-k of his own property and the electronic apparatus 1-k so as to register a drawing code in the electronic apparatus 1-k and the remote control device. At this time, when the remote control information is recorded in the remote control information recording unit 22 of the remote control device 2, the control unit 21 of the remote control device 2 displays various buttons on the display portion 27 on the basis of the remote control information. On the contrary thereto, when the remote control information is not recorded in the remote control information recording unit 22, the control unit 21 displays character such that “No remote control information is recorded yet”.

Under this state, the user conducts a predetermined input operation into the instruction input unit 26. Then in the remote control device 2, the control unit 21 starts a process shown in FIG. 9 and a display process in Step S1. Thereafter, it is in a state of judging whether or not an input of the drawing code is completed in Step S2. The process of the same step is repeated to until the input of the drawing code is completed along “no” in Step S2. The content of the operation is arbitrary at this time. For example, it may possible to locate the button for registering the drawing code in the instruction input 26 unit and to make the control unit 21 start the process when the button is pressed down.

When such a display process is conducted, the display unit 27 displays the character string “please input drawing code” and a button for inputting the characters. Under this state, when the user inputs a number of for example “1” as the drawing code, the control unit 21 judges “yes” in Step S2, generates the character code of for example “Please input the keyword” and image data for displaying the buttons which are used to input the keywords, and outputs these onto the display unit 27 in Step S3. Then the control unit 21 waits the input of the keywords by the user in Step S4. The process in the step is repeated until the input by the user in completed along “no”. Under this state, when the character string of “DVD” is inputted by the user, the control unit 21 judges “yes” in Step S4, and records the drawing code “1” and the keyword of “DVD” which are inputted by the user in the drawing code recording unit 23 by making the drawing code and the keyword correlated in Step S5.

Next, the control unit 21 outputs image data for showing such as “The drawing code is sent to the electronic apparatus to be registered. Please direct the remote control device toward the electronic apparatus to be registered and push the send button” on the display unit 27 in Step S6. Then in Step S7, it is in a state whether or not the send button is selected by the user. Under this state, for example, if the user makes the DVD recorder confront with the remote control device 2 and does a predetermined input operation to the instruction input unit 26, the control unit 21 judges “yes” in Step S7 and send the inputted drawing code D1 through ths sending unit 24 to the electronic apparatus 1-k in Step S8. Then the process is completed.

Meanwhile, when the drawing code D1 which is sent by the remote control device 2 is received by the receiving unit 25, the electronic apparatus 1-k records the received drawing code D1 into the drawing code recording unit 124 of the electronic apparatus 1-k in Step S11. Thus the process is completed. By conducting the above process, the drawing codes corresponding to the various electric apparatuses are registered, and the drawing codes are commonly owned by the remote control device 2 and the electronic apparatus 1-k.

(2) Operation of Controlling Electronic Apparatus

First, the user throws an electric power to the electronic apparatus 1-k and the remote control device 2 so as to start the remote control of the electronic apparatus 1-k. At this time, in a manner similar to the above, the already recorded remote control information displays various buttons on the basis of the remote control information or displays characters such as “No remote control information is recorded yet”.

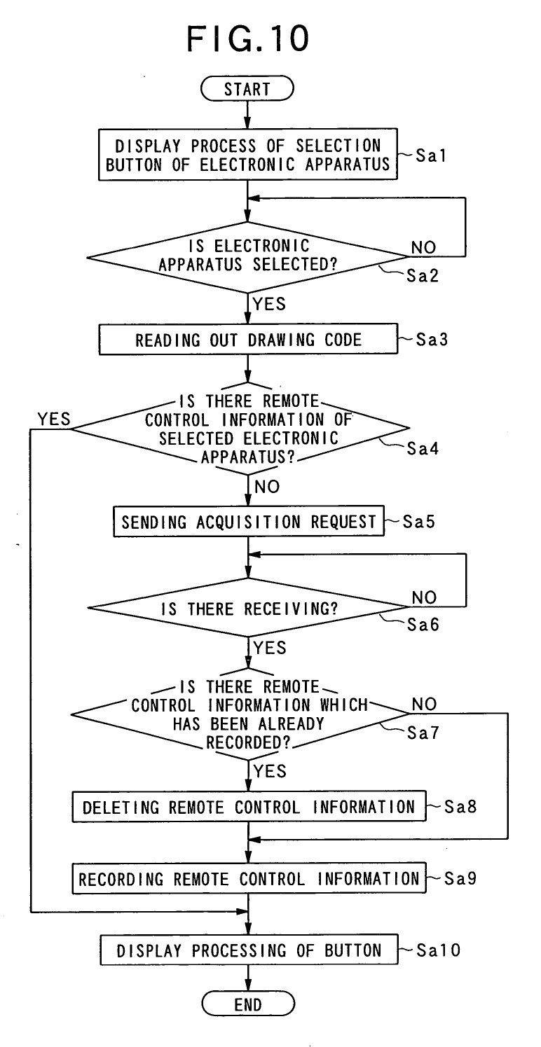

Under this state, the user conducts a predetermined input operation on the instruction input unit 26. Then the control unit 21 of the remote control device 2 starts the process of showing the flowchart of FIG. 10. In this process, the control unit 21 first generates image data for selecting the electronic apparatus to be controlled and displays it in the display unit 27 in Step Sa1. Thereafter, the control unit 21 waits an input operation by the user along “no” in Step Sa2. In this display process, the control unit 21 reads out the keyword which is recorded in the drawing code recording unit 23 and generates the image data using the keyword.

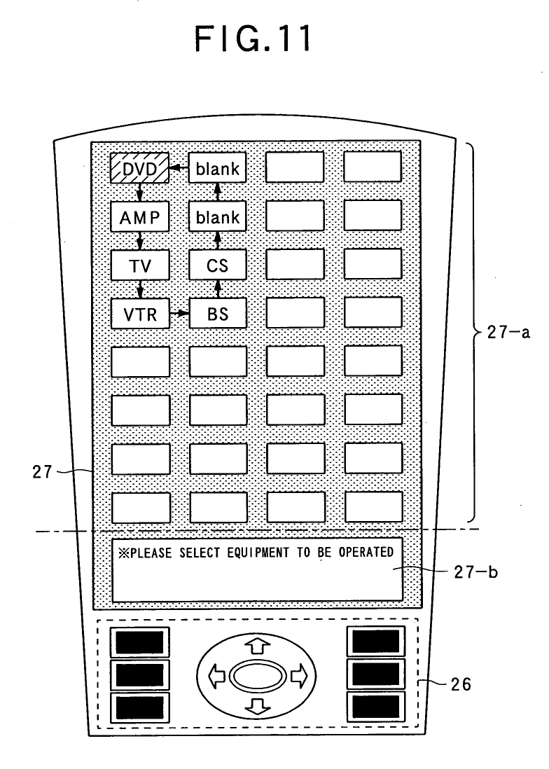

FIG. 11 shows an example of an image displayed on the display unit 27 in Step Sa1. As illustrated in the figure, at this time, for example, a button for selecting the electronic apparatus 1-k is displayed in a button display area 27-a of the display unit 27. The keywords which are recorded in correspondence with the drawing codes are displayed as character strings such as “DVD”, “AMP” and “TV”.

Under the state, the user conducts the input operation of selecting the button of “DVD” as the electronic apparatus 1-1. Then the control unit 21 judges “yes” in Step Sa2 and reads out the drawing code which is recorded in the drawing code recording unit 23 in correspondence with the keyword described in the selected button in Step Sa3.

Next, the control unit 21 judges whether or not the remote control information is already recorded in the remote control information recording unit 22 in Step Sa4. The judgment of the time is arbitrary. For example, when the remote control information recording unit 22 records the remote control information, the drawing code may be recorded in correspondence with the remote control information so as to be judged whether or not the drawing code matches the read out drawing code.

Further, in this Step Sa4, when it is judged that the remote control information is recorded along “yes”, the control unit 21 displays various buttons based on the button information a-2 of the remote control information and the body information bin Step Sa8. Then the process is completed.

On the contrary thereto, when the remote control information is in a state of not being recorded yet along “no” in Step Sa4, the control unit 21 sends an acquisition request including the drawing code which is read out in Step Sa3, i.e. the drawing code corresponding to the electronic apparatus 1-k which is selected by the user, in Step Sa5. When such sending is completed, the control unit 21 is in a state of judging whether or not the remote control information is received or not in Step Sa6, and repeats the process of the same step until the remote control information is received along “no”.

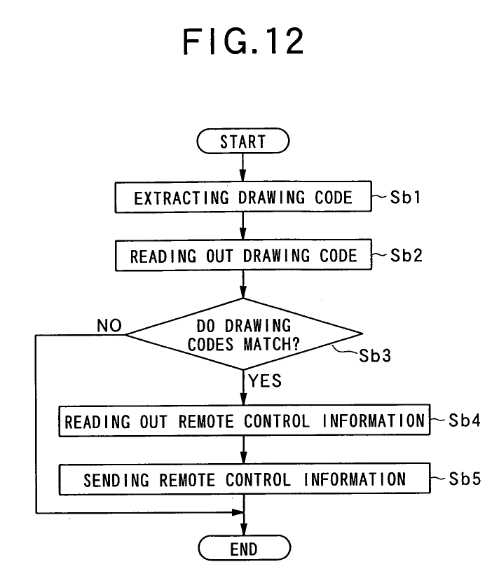

Meanwhile, when the acquisition request is received by the receiving unit 121 of the electronic apparatus 1-k, the remote control unit 123 starts the process shown in FIG. 12. FIG. 12 is a flowchart for showing a process which is executed by the remote control unit 123 of the electronic apparatus 1-k.

As shown in the figure, in the process, the remote control unit 123 first extracts the drawing code which is contained in the acquisition request in Step Sb1, reads out the drawing code which is recorded in the drawing code recording unit 124 of the own device in Step Sb2, and judges whether or not both of the drawing codes match in Step Sb3. As a result of this judgment, when the both of the drawing codes does not match, the acquisition request is judged not to be the own electronic apparatus 1-k. Therefore, when it is judged to be “no” in Step Sb3, the remote control unit 123 terminates the process without sending the remote control information corresponding to the own device.

On the other hand, when the both of the drawing codes matches, the acquisition request is directed to the electronic apparatus 1-k. Accordingly, when it is judged to be “yes” in Step Sb3, the remote control unit 123 reads out the remote control information corresponding to the own device in Step Sb4 and sends the read-out remote control information to the remote control device 2 in Step Sb. Thus the process is completed.

By this process, the remote control information is received by the receiving unit 25 of the remote control device 2, the control unit 21 judges “yes” in Step Sa6 of FIG. 10, and it is judged whether or not the remote control information is already recorded in the remote control information recording unit 22 in Step Sa7. When it is judged to be “yes” as a result of the judgment, the remote control information which is already recorded in the remote control information recording unit 22 is deleted in Step Sa8, and the remote control information which is sent from the electronic apparatus 1-k is recorded in the remote control information recording unit 22 in Step Sa9.

On the contrary thereto, when the remote control information is not recorded in the remote control information recording unit 22 along “no” in Step Sa7, the control unit 21 records the remote control information as is in the remote control information recording unit 22 in Step Sa9. The remote control unit 21 generates the image data corresponding to the operation screen on which various buttons are arranged on the basis of the remote control information Da2 and supplies these to the display unit 27 in Step Sa10. Thus the process is completed. At this time, the control unit 21 sets the operation area of the touch panel so as to be in correspondence with the operation screen.

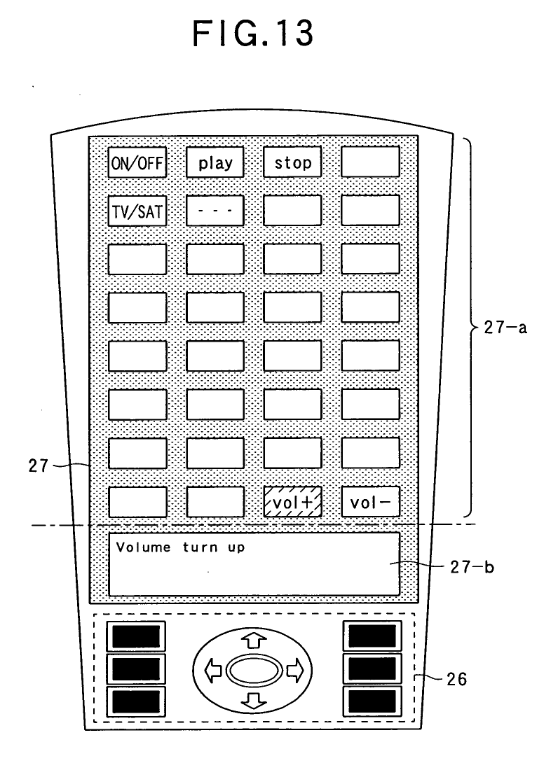

An example of the image which is displayed on the button display area 27-1 of the display unit 27 in this state is shown in FIG. 13. The example of the display in this figure corresponds to the remote control information shown in FIG. 4. For example, as shown in the figure, at this time, the operation screen on which various buttons are arranged in correspondence with various commands which corresponds to the electronic apparatus is displayed on the button display area 27-a. An arrangement position of each of the buttons is determined on the basis of the button information a-2 of the remote control information. For example, when the button is displayed on the basis of the example shown in FIG. 4, the buttons of from No. “0” to No. “97” are arranged in rows as many as 25 and columns as many as 4 from the uppermost row of the left end column. Further, at this time, the button name of the body information b is displayed as information of showing the command which corresponds to the button. As the result, for example in a case of the remote control information shown in FIG. 4, the buttons “ON/OFF”, “play”, “stop”, . . . , and “Vol-” are displayed. According to the above process, when the buttons are displayed on the display unit 27, the control unit 21 is in a state of waiting the signal inputted from the touch panel of the instruction input unit 26. Under the state, when an input operation is conducted by a user to select from the displayed buttons, the control unit 21 extracts the remote control code corresponding to the selected button out of the body information band outputs the remote control code to the sending unit 24. As a result, the remote control code is modulated by a carrier wave and sent to the electronic apparatus 1-k as a control signal.

Meanwhile, in the electronic apparatus 1-k, the remote control unit 123 controls the original operation unit 11 on the basis of the remote control code which is obtained by demodulating the control signal. For example, when the electronic apparatus 1-k has a structure shown in FIG. 2 and the remote control code which is sent by the remote control device 2 corresponds to the “play” command, namely that corresponds to a reproduction command for a medium, the remote control unit 123 outputs a control signal to the record and reproduction unit 115 in accordance with the remote control code. As a result, the control signal is outputted to the media drive 113, and content data are read out of the media which is inserted in the media drive 113 and inputted into the decoder 112. The content data are demodulated by the decoder 112, outputted to the monitor as an image signal, and displayed on the monitor.

(3) Operation at a Time of Changing the Display Mode

When the display mode of the operation screen of the remote control device 2 is changed, a user is first required to do a predetermined input operation on the instruction input unit 26 of the remote control device 2. Although the content of the operation is arbitrary, in this embodiment a button for exclusively used to changing the mode (hereinafter referred to as a “FIX button”) is provided to conduct the following process when the button is pushed down.

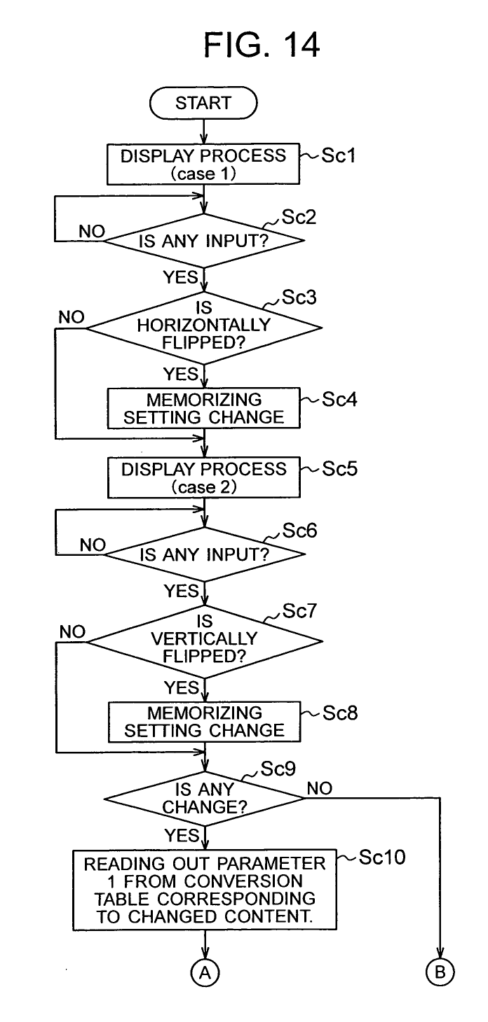

After the control unit 21 starts to process as in the flow chart shown in FIGS. 14 to 16 upon a push of the FIX button. The control unit 21 generates an image data and outputs it to the display unit 27 in Step Sc1. Thereafter, it is queued for an input operation by the user along “no” in Step Sc1. As a result, the display unit 27 displays two buttons of “yes” and “no” along with a character string of for example “Case 1 will be set. Do you want to horizontally reverse the button arrangement?” It is arbitrary to display the character string in any mode. For example, it can be displayed on an entire range of the display unit 27 or only on an auxiliary area 27-b.

Under the condition, the user is required to select any of the buttons “yes” and “no”. When the user does an input operation of selecting any of the buttons, the control unit 21 judges “yes” is Step Sc2. Thereafter, it is judged whether or not the button arrangement is horizontally reversed in Step Sc3.

In this, when the user selects the button of “yes”, the control unit 21 judges “yes” in Step Sc3, and make the setting change memorize in the RAM (not shown) in Step Sc4. Thereafter, it is queued for an user input along “no” in Step Sc6. On the contrary thereto, when it is judged “no” in Step Sc3, the control unit 21 again generates image data and outputs these to the display unit 27 in Step Sc5. Thereafter, it is queued for an user input along “no” in Step Sc6.

According to such a display process, an image which is displayed on the display unit 27 of the remote control device 2 is changed to an image including a character string such as “Case 2 will be set. Do you want to vertically reverse the button arrangement?” and two buttons of “yes” and “no”. In the state, when the user selects any one of “yes” and “no”, the control unit 21 judges “yes” in Step Sc6. Thereafter, it is queued for an user input along “yes” in Step Sc7.

When the user selects the button of “yes”, the control unit 21 judges “yes” in Step Sc7 and the setting change is memorized in RAM in Step Sc8. Thereafter, it is judged whether or not the content of the setting change is memorized in RAM in Step Sc9. When it is judged “yes” in Step Sc9, the control unit 21 reads out the setting change and reads out the parameter 1 out of a conversion table corresponding to the setting change in Step Sc10. At this time, the control unit 21 extracts the arrangement pattern information which is recorded in the remote control information recording unit 22 and judges which of (a)horizontal reverse, (b)vertical reverse, and (c) horizontal and vertical reverse is done from the setting change content which is memorized in the RAM. Then the parameter 1 corresponding to the arrangement pattern information extracted from the remote control information is read out the conversion table corresponding to the reverse content. The control unit 21 makes the parameter thus read out memorize in the RAM in Step Sc11. Image data are again generated and outputted to the display unit 27 in Step Sc12. Then it is queued for an user input along “no” in Step Sc13.

On the other hand, when it is judged to be “no” in Step Sc9, the control unit 21 generates image data and outputs it to the display unit 27 without conducting Steps Sc10 and Sc11 in Step Sc12. Thereafter, it is queued for an input operation by an user along “no” in Step Sc13. By conducting the display process, the image displayed on the display unit 27 of the remote control unit 2 is changed to a character string such as “Case 3 will be set. Do you want to change the density of the button arrangement?” and an image made up of two buttons of “yes” and “no”. In this state, when the user selects any one of the buttons of “yes” and “no”, the control unit 21 judges “yes” in Step Sc13. Thereafter, it is in a state of judging whether or not the content is to select the button of “yes” in Step Sc14.

As a result of the judgment, when “no” is selected the control unit 21 conducts a display process of Step Sc19 without conducting the process of the steps of Sc15 to Sc18. On the contrary, when it is judged “yes” in Step Sc14, The control unit 21 extracts the button number information contained in the remote control information and calculates the arranged button number which can be crosswise set on the basis of a display capability of the display unit 27 in Step Sc15.

In this, a practical calculation method for obtaining the number of the arrangement buttons which can be set by the control unit 21 in the crosswise direction. For example, the button numbers which can be displayed in the display portion 27 in the crosswise direction and the vertical direction are memorized in a ROM (not shown) of the control unit 21, and the number of the arrangement buttons may be determined on the basis of these button number and the button number information. In this case, for example, when the button number information is “98”, the number which is memorized in the RAM as can be displayed is “5” in the crosswise direction and “40” in the lengthwise direction, the range which can be set in the crosswise direction resides in from “3” to “5”.

Next, when the numbers which can be arranged are calculated, the control unit 21 conducts the display process again. Then, buttons for selecting the numbers which are calculated in Step Sc15 so as to be able to be arranged are displayed along with a character string such as “Please select the button arrangement number in the crosswise direction” on the display unit 27 in Step Sc16. Then it is queued for an user input along “no” in Step Sc17. In this state, when a user conducts an input operation of selecting the button corresponding to the button arrangement number which is requested by the user, the control unit 21 generates the arrangement array information and makes it memorize in the RAM in Step Sc18. Then the control unit 21 subtracts the number designated by the button number information by the button number which is set and selected by the user to calculate the number of stages in the lengthwise direction.

Further, in Step Sc19, the control unit 21 generates the image data and outputs these to the display unit 27. A character string “Case 4 will be set. Do you want to change the position the button arrangement?” and an image made up of two buttons of “yes” and “no” are displayed in the display unit 27. Then it is queued for a user input along “no” in Step Sc20. When a user conducts an input operation, the control unit 21 judges “yes” in Step Sc20. In Step Sc21, it is judged whether or not the user input is a content for selecting the “yes” button. When it is judged to be “no”, the process of Step Sc28 is executed without conducting Steps Sc22 to Sc27.

On the contrary thereto, when it is judged to be “yes” in Step Sc21, the control unit 21 reads out remote control information which is recorded in the remote control information recording unit 22 and displays an operation screen according to the remote control information. At the same time, a character string such as “Please select a button of which button arrangement position is changed” is displayed in Step Sc22. Then it is queued for a user input along “no” in Step Sc23. Under this state, when the user conducts an input operation of selecting the button of which button number is changed, the control unit 21 judges “yes” in Step Sc23, generates image data for displaying a character string such as “Please designate the destination of move”, and outputs the image data to the image data in Step Sc24. Then it is queued for a user input along “no” in Step Sc25.

Next when a user conducts an input operation for designating the destination of move, the judgment in Step Sc25 becomes “yes”, and the control unit 21 extracts the button numbers corresponding to the buttons which are selected in Steps Sc23 and Sc25 out of the body information b of the remote control information, and makes the button numbers memorize in the RAM along with this correspondence in Step Sc26. The control unit 21 judges whether or not the selection of the button to be changed is completed in Step Sc 27. When if it is judged that the selection is not ended along “no”, the processes of Steps Sc22 to Sc27 are conducted.

On the contrary thereto, when it is judged to be “yes” in Step Sc27, the control unit 21 generates an arrangement table file on the basis of the parameter 1 which is memorized in the RAM, the array arrangement information, and the button number in Step Sc28. When the arrangement table file is generated, the control unit 21 conducts redisplay of the operation screen, generates image data corresponding to the operation screen on the basis of the arrangement table file, and outputs these to the display unit 7 in Step Sc29. Then the processes are completed.

At this time, the control unit 21 reverses the arrangement state of the buttons in the image data which corresponds to the operation screen and changes the button density on the basis of the arrangement array information in accordance with the parameter 1 that is described in the arrangement table file. At this time, the control unit 21 changes the arrangement position of the buttons in the image data corresponding to the operation screen on the basis of the corresponding relationship of the button numbers which are described in the arrangement table file. Further, in this case, the control unit 21 changes the operation area of the touch panel of the instruction input unit 26 so as to correspond to the operation screen after changing the mode.

As a result of the above process, the display unit 27 displays the operation screen in the mode corresponding to the arrangement table file. It is arbitrary whether or not the arrangement table file is stored as a setting content. When the arrangement table file is stored, a place of recording the arrangement table file is arbitrary. For example, the arrangement table file may be recorded in correspondence with the remote control information in the remote control information recording unit 22, and the arrangement table file may be deleted when the remote control information which is already recorded in the remote control information recording unit 22 is deleted by switching over the electronic apparatus 1-k to be controlled. Further, when the arrangement table file is stored in the drawing code recording unit 23 in correspondence with the drawing code, it becomes possible to change the display mode by reading out the arrangement table file at the time of obtaining the remote control information from the electronic apparatus 1-k to be controlled.

In such a display mode, when the user conducts the input operation for selecting a button on a touch panel which is set on the display unit 27 of the remote control unit 2, the control unit 21 reads out a remote control code which is described in the remote control information in correspondence with the button number corresponding to the button and sends it as the remote control signal.

As such, the remote control device 2 according to this embodiment is to remotely control the electronic apparatus 1-k and has a structure made up of the remote control information recording unit 22, the control unit 21 for displaying the operation screen in which a plurality of buttons for selecting each of the processes which are defined by the remote control information on the display unit 27, the instruction input unit 26 which is attached to a surface of the display unit 27 and has an operation area for receiving the input operation to the instruction input unit 26 by the user, and the sending unit 24 which sends at least a part of the remote control information to the electronic apparatus 1-k, wherein the control unit 21 changes the operation screen to be displayed on the display unit 27 in response to the input operation by the user and also changes the operation area on the touch panel in response to the change of the operation screen.

According to this structure, the display mode is changed by the control unit 21 to change the operation position on the touch panel. As a result, according to the remote control device 2 according to this embodiment, it is possible to improve user-friendliness while suppressing the increment of the manufacturing cost of the remote control device 2.

Further, in the remote control device 2 according to this embodiment, the remote control information recording unit 22 has a structure of recording the remote control information which includes at least remote control codes corresponding to executive instructions of various processes in the electronic apparatus 1-k, button names corresponding to each of the buttons, and button information a-2 and button number which designate arrangement positions of each of the buttons on the operation screen, wherein the control unit 21 displays the operation screen on the basis of the button name, the button information, and the button number which are included in the remote control information.

According to the structure, the operation screen having the buttons arranged thereon is displayed on the display unit 27 in compliance with the button information a-2 and the button number, and the button names are displayed on each of the buttons. Accordingly, it becomes possible to arbitrarily determine the button arrangement in accordance with the remote control information, whereby the degree of freedom in design can be kept.

Further, the remote control device 2 according to this embodiment has a structure such that the instruction input unit 26 has an operating element such as a cursor key for instructing the change of the arrangement position of the buttons in the operation screen, and the control unit 21 generates the arrangement table file which indicating the arrangement position after changing the arrangement position and the operation screen is displayed on the basis of both of the arrangement table file and the button names.

According to this structure, the arrangement table file is generated in response to a content instructed by the user and the operation screen is displayed on the basis of the arrangement table file. Therefore, it becomes possible to freely design an operation screen in response to the input operation and to improve operationality of the remote control device 2 by the user.

Further, the remote control device 2 according to this embodiment, the control unit 21 has a structure of display the operation screen on the basis of the button names contained in the generated arrangement table file and the remote control information without adding change to the remote control information itself. According to this structure, because the arrangement table file is separately generated with respect to the remote control information, it becomes possible to store the content set by the user.

Furthermore, the remote control device 2 according to this embodiment employs a structure such that the control unit 21 generates the arrangement table file for at least horizontally flipping the arrangement position of each of the buttons in the operation screen in a case where the input operation is done to change the arrangement position of the buttons on the operation screen with respect to the instruction input unit 26, and the operation screen is is displayed on the display unit 27 on the basis of both the arrangement table file and the button names. According to this structure, because the arrangement position of each of the buttons is displayed in a horizontally flipped state, even in a case where the dominant hand of a user is different, it becomes possible to realize the most suitable operationality for each of the users.

Further, the remote control device 2 according to this embodiment employs the structure such that the control unit 21 generates the arrangement table file at least for vertically flipping the arrangement positions of the buttons in the operation screen in a case where an input operation is done to change the arrangement position of each of the buttons with respect to the instruction input unit 26, and the operation screen is displayed on the display unit 27 on the basis of both of the generated arrangement table file and the button names. According to this structure, since the arrangement positions of each of the buttons are displayed in a vertically flipped state, the user can set the arrangement position of each of the buttons in more detail.

Furthermore, the remote control device 2 according to this embodiment employs a structure such that the control unit 21 generates the arrangement table file for changing gaps of each of the buttons with respect to the instruction input unit 26, and the operation screen is displayed on the display unit 27 on the basis of both of the generated arrangement table file and the button names. According to this structure, the gaps in displaying each of the buttons are changed. Namely, the display density of the buttons is changed according to the structure. Therefore, even though the user is an adult or a child, it is possible to realize most suitable operationality for any of the users.

Furthermore, the remote control device 2 according to this embodiment employs a structure such that the control unit 21 generates at least an arrangement table file for changing the arrangement positions of the buttons which are designated by the user to a position designated by a user in a case where the input operation is conducted to change the arrangement positions of each of the buttons with respect to the input instruction unit 26, and the operation screen is displayed on the display unit 27 on the basis of both the arrangement table file and the button names. According to this structure, since the display positions of the each of the buttons which are designated by the user are changed, it becomes possible to customize an operation screen user by user and therefore provide operationality which fits more to tastes of users.

Meanwhile, this embodiment employs a structure such that the drawing code of the electronic apparatus 1-k and the keyword are related and recorded in the drawing code recording unit 23. However, when only the drawing code is memorized in the drawing code recording unit 23 and the keywords are not recorded, the capacity of the nonvolatile memory which is equipped in the remote control device 2 is reduced and the manufacturing cost of the remote control device 2 can be reduced. However, in this case, it is necessary that the user memorizes electronic apparatuses 1-k corresponding to each of the drawing codes.

Further, this embodiment has a structure that the drawing code is set by a user. However, it may be possible to control the electronic apparatus 1-k by previously determining the drawing code and control the electronic apparatus 1-k by using the drawing code. In this case, by previously recording drawing codes and model names which correspond to each of the electronic apparatuses in the drawing code recording unit 23, the process similar to that in the electronic apparatus 1-k can be conducted.

Furthermore, although an example of the remote control information is shown in FIG. 4, the data format of the remote control information may be in any type. As long as information stipulating a content similar to the button number information, the arrangement array information, and the arrangement pattern information is contained, data of any format may be used. Especially, as for the arrangement pattern information, a content similar to the content defined by these parameters may be defined by another format without stipulating the parameter 1 and 2, and further it can be defined by one parameter obtained by combining these parameters.

Further, the electronic apparatus 1-k according to this embodiment adopts a structure of sending the remote control information corresponding to the own device to the remote control device in an as-is mode. However, it is possible to encrypt the remote control information by the drawing code in the electronic apparatus 1-k and send to the remote control device 2, and decrypt the encrypted remote control information by the drawing code.

Furthermore, in this embodiment, the structure of generating the arrangement table data in the remote control device and change the display mode of the buttons in the remote control device 2 in use of the arrangement table data is adopted. However, the process operation similar to the above may be conducted by preparing a recording medium in which a program for stipulating the process operation is recorded and a computer for reading out it and by reading the program.

Further, in this embodiment, the button names which are made up of character information are described in the remote control information and the button names are used when each of the button names is displayed. However, it is possible to form the images which are displayed in the buttons by graphic data instead of the button names.

Further, in this embodiment, although the structure that the electronic apparatus 1-k sends the remote control information in response to the acquisition request from the remote control device 2 is adopted, it may possible to conduct the process operation by preparing a recording medium in which a program for stipulating the process operation is recorded and a computer for reading out it and by reading the program as in the above.

[1.3] Modified Example

(1) Modified Example 1

In the Embodiment 1, a structure such that the remote control device 2 generates the arrangement table file on the basis of the content set by the user and a mode of displaying the button on the display unit 27 is employed. However, it is possible to change the display mode of the remote control device by changing the remote control information itself without generating the arrangement table file

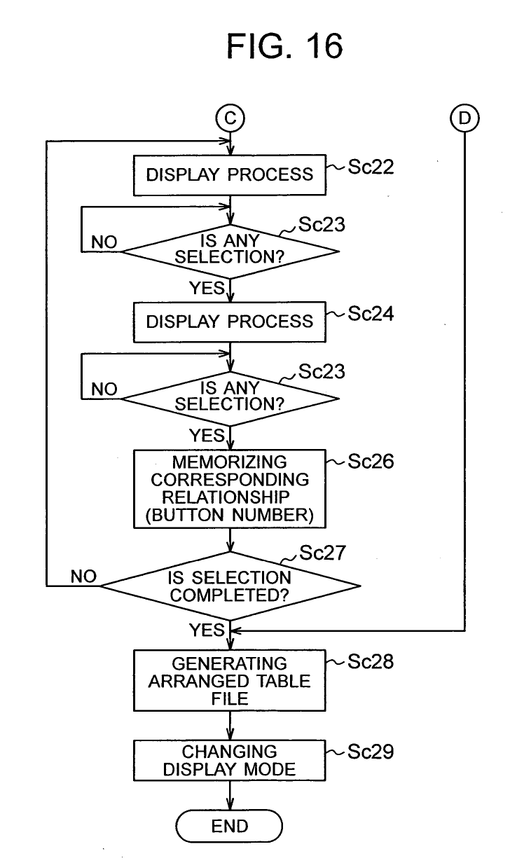

When such a structure is adopted, it is necessary to read out the parameter 1 which is memorized in the RAM, the arrangement array information, and the button number and replace this information with the read-out information in Step Sc28 of the FIG. 16. In Step Sc29 of FIG. 16, the buttons are redisplayed on the basis of the changed remote control information to thereby change the display mode of the buttons on the display unit 27.

As such, the remote control device 2 according to this modified example has a structure such that the control unit 21 rewrites to replace the arrangement data which are contained in the remote control information with the generated arrangement pattern information or the like and the operation screen is displayed on the basis of the remote control information after the replacement. According to the remote control device 2 according to the modified example, it is possible to change the display mode at the time of displaying the operation screen on the basis of the remote control information without generating the arrangement table file at the time of displaying the operation screen on the basis of the remote control information and to improve user-friendliness while suppressing the increment of the manufacturing cost of the remote control device.

According to this structure, it becomes possible to change the display mode of the buttons in the remote control device 2 without generating the arrangement table data in the remote control device 2.

(2) Modified Example 2

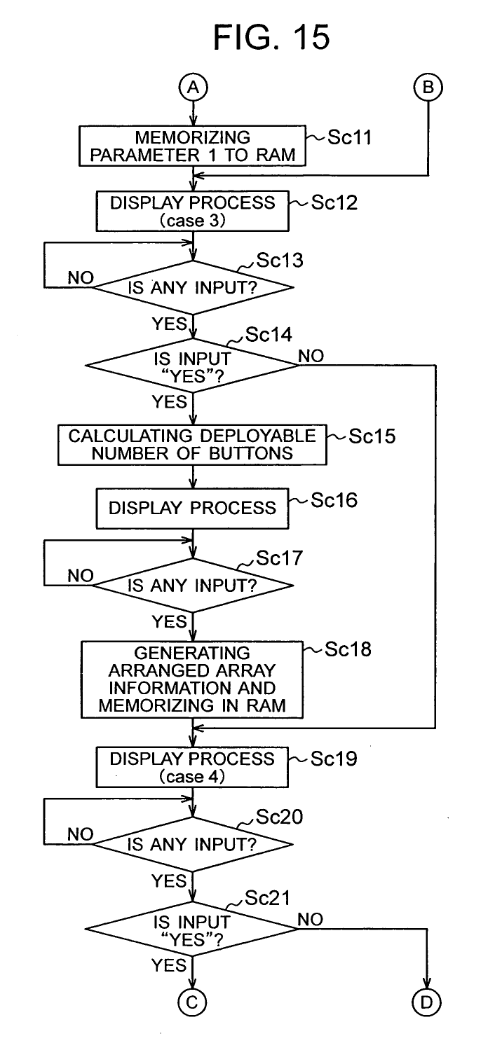

In Embodiment 1, a structure that the button number information contained in the control unit 21 of the remote control device 2 is extracted in Step Sc15 of FIG. 15 and the number of the arrangement buttons which can be set in the crosswise direction is calculated is adopted. However, the number of the buttons which can be displayed on the remote control device 2 can be determined without relying on the button numbers which can be displayed in the lengthwise and crosswise directions.

However, when such a method is adopted, there may be a case where all buttons are not displayed at once on the display unit 27. For example, when the button number information is “98”, when it is tried to display in “1” column and “98” rows or in “98” columns and “1” row, there may be a case where these buttons are not displayed all at once.

Accordingly, when such a method is adopted, it is necessary to select all the buttons by any of the following methods.

(a) Method 1

The method 1 is a method of generating image data on which all buttons are arranged, and displaying the operation screen while scrolling the operation screen in response to the predetermined input operation. When this method is adopted, the control unit 21 is required to constantly change the operation area of the touch panel so as to correspond to the display state of the operation screen.

(b) Method 2

The method 2 is a method of generating image data corresponding to the operation screen by dividing the image data into a plurality of pages. In this case of using this method, the control unit 21 generates the image data of depicting for example a button of “next page” inside the operation screen and outputs it to the display unit 27. At the same time, in a case where an input operation is done to the instruction input unit 26 to select the button, image data corresponding to a new page are generated and inputted again to the display unit 27. At this time, it is required to change the operation area of the touch panel so as to correspond to operation screens of each of the pages as in a manner similar to the above method 1.

(3) Modified Example 3

In Embodiment 1, the remote control device 2 achieves “case 1” to “case 4” as modifications of the display mode. On the contrary thereto, the remote control device 2 according to this modified example is to further achieve the modification of the display mode of the following “case 5”.

(Case 5)

This modified mode is to reduce the number of the buttons to be less than the number of the buttons corresponding to the button number information which is described in the remote control information. Such a change of the display mode is attained by describing information for replacing the arrangement table file with the button number information and determining the button number on the basis of the information.

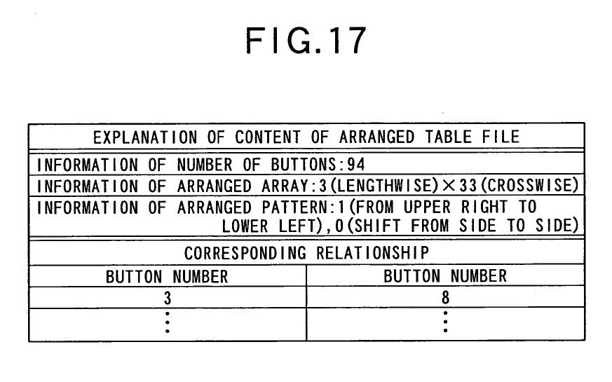

An example of the arrangement table file when the display mode corresponding to “case 5” is achieved to be changed is shown in FIG. 17. As shown in the figure, in this modification, the button number information for replacement with respect to the remote control information is described in the arrangement table file along with the content shown in FIG. 8. In the remote control device 2, when the operation screen is displayed in accordance with the arrangement table file, the buttons are displayed in the following relationship.

<Principle>

The control unit 21 displays the buttons as much as 94 sequentially from the top of the button number. For example, in a case shown in FIG. 4, the control unit 21 displays only buttons as much as 94 from No. “0” to No. “93”, and four buttons of No. “94” to No. “97” are not displayed.

<Exception>

When the relationship of the button numbers is described in the arrangement table file, i.e. when a user changes a display mode of the above “case 4” and the buttons are replaced, the control unit 12 displays as follows. Namely, the buttons as many as the number corresponding to the number to be deleted which are counted from the most lately displayed button are not subjected to display among the buttons left after replacing the buttons. For example, in a case shown in FIG. 4, when the button of “97” is replaced by the button No. “2”, the control unit 21 sequentially arranges the button of No. “97” in place of the position where the button of No. “2” should be displayed, the button of No. “2” in place of the arrangement position of No. “3”,and the button of No. “3” in place of the arrangement position of No. “4”. As a result, the remote control device 2 displays 94 buttons of No. “0”, No. “1”, No. “97” and, Nos. “2” to “91”.

Such a change of the display mode especially demonstrates its user-friendliness when the remote control device 2 is used under he following circumstance. Namely, in a home including a child, it may occur that the child cancels a picture recording of a program in mischief even after the picture recording is set. In order to avoid such a situation, it is necessary to prohibit a operation of a button for canceling a picture recording by not displaying the button. In this case, the button corresponding to the cancel command of the picture recording is sequentially replaced by the following buttons to reduce the number of the displayed buttons. By this, the situation is avoidable.

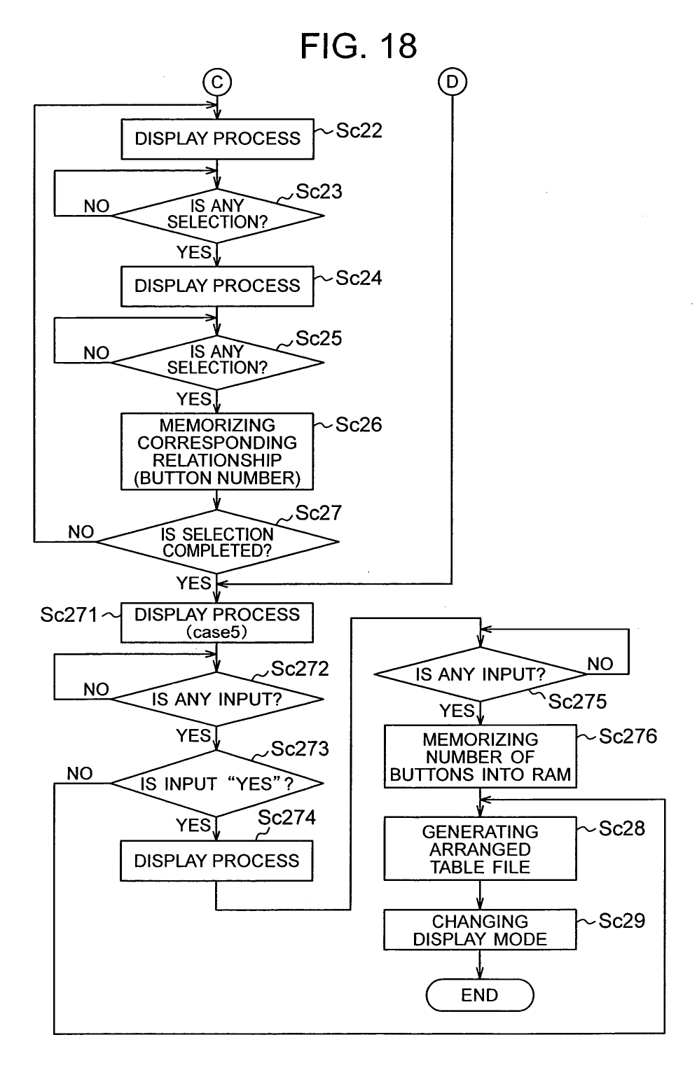

As a specific processing method, it is realized by making the control unit 21 conduct a process shown in FIG. 18 after a process shown in FIG. 15. In FIG. 18, the steps similar to those in FIG. 16 are designated by similar numerical references.

In this process, the control unit 21 conducts the processes of Steps Sc22 to Sc27 and thereafter generates image data and outputs it to the display unit 27 in Step Sc271. Then, it is queued for a user input while displaying a character string of such as “case 5 will be set. Do you want to reduce the number of the buttons to be displayed?” and an image made up of two buttons of “yes” and “no” in the display unit 27 along “no” in Step Sc272. Then after the user conducts an input operation, the control unit 21 judges “yes” in Step Sc 272 and judges whether or not the user's input is for selecting the “yes” button in Step Sc272.

In a case where it is judged to be “no” in this judgment, the control unit 21 generates the arrangement table file without conducting processes of Steps Sc274 to Sc276. On the contrary thereto, when it is judged to be “yes” in Sc273, the control unit 21 conducts the display process, generates image data, and outputs it to the display unit 27 in Step Sc274. Then it is queued for a user input along “no” in Step Sc275. As a result, the display unit 27 displays a character string such as “Please input the number of the display buttons”.

In this state, when the user conducts an input operation for designating th button number to the user instruction input unit 26, The control unit judges “yes” in Step Sc275, and memorizes the button numbers which are inputted by the user in the RAM in Step Sc276. The control unit 21 generates the arrangement table file in which the button number memorized in the RAM is described in Step Sc 28. In Step Sc29, the display mode is changed. Then the process is completed.

As such, in the remote control device 2 according to this modified mode, an instruction input unit 26 has an operating element such as a cursor key for instructing to change the change of the arrangement number of the buttons on the operation screen. It is constructed such that when an input operation is conducted, the control unit 21 generates the arrangement table file for showing the number of the arrangement after the change and displays the operation screen on the basis of both the arrangement table file and the remote control information.

According to this structure, when the change of the arrangement number of the buttons is indicated with respect to the instruction input unit 26, the arrangement table file showing the arrangement number is generated by the control unit 21, and the operation screen is displayed on the basis of both of the arrangement table file and the remote control information. Accordingly, it becomes possible to arbitrarily change the number of the buttons which are displayed on the operation screen and further not to display buttons which the user arbitrarily wish to prohibit operation thereon.

### [2] Embodiment 2

A remote control system S according to this embodiment can be realized by a structure similar to that in the remote control system S according to Embodiment 1 shown in FIG. 1. Accordingly, each of the elements has the same structure as the element shown in FIG. 1 and does the same movement, if not specifically described. The remote control system S makes an arrangement table file which is generated in a remote control device 2 control in an electronic apparatus 1-k, and makes the arrangement table file thus controlled send to the remote control device 2 in response to a request from the remote control device 2.

In order to realize such function, after the remote control device 2 according to the embodiment generates the arrangement table file in Step Sc28 of FIG. 16 as described above, the generated arrangement table file is sent to the electronic apparatus 1-k. Thus the arrangement table sent from the remote control device 2 is recorded in the electronic apparatus.

When a remote control device 2 is owned by a plurality of users, it is foreseeable that preferences of the users for the display mode of the remote control device 2 are different. Therefore, in this embodiment, setting numbers are sequentially allocated from No. “1” in the remote control device 2 when the arrangement file is generated, and the arrangement table file is identified on the basis of the setting number.

This setting number is allocated for each of the electronic apparatuses and utilized by combining with a drawing code. For example, under a circumstance where two electronic apparatuses exist and drawing codes of “1” and “2” are allocated respectively to the electronic apparatuses, a case where two arrangement table files are generated with respect to the electronic apparatus 1-k corresponding to the drawing code of “1”, and four arrangement table files are generated with respect to the electronic apparatus corresponding to the drawing code of “2” is considered. In this case, the setting numbers of “1” and “2” are allocated to the electronic apparatus 1-k of the drawing code of “1” and the setting numbers of “1” to “4” are allocated to the electronic apparatus 1-k of the drawing code of “2”. Therefore, by combining the drawing code with the setting number, it becomes possible to specify, for example, which arrangement table is set with respect to which electronic apparatus 1-k.

In this embodiment, the remote control device 2 adds the setting number which is allocated to the arrangement table file at the time of sending the arrangement table file to the electronic apparatus 1-k and sends it to the electronic apparatus 1-k. In the electronic apparatus 1-k, the setting number is recorded in correspondence with the arrangement table file. It is arbitrary to determine to which part of the electronic apparatus 1-k these data are recorded. For example, it is possible to record into a drawing code recording unit 124 and the remote control information recording unit 125. Otherwise, a recording place may be separately prepared.

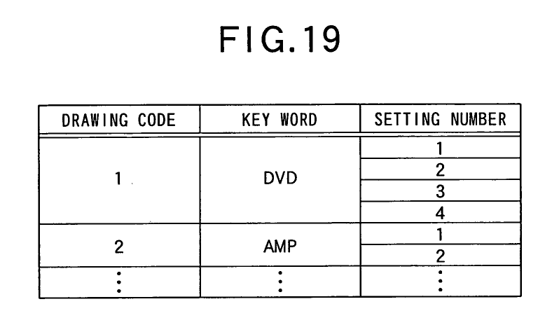

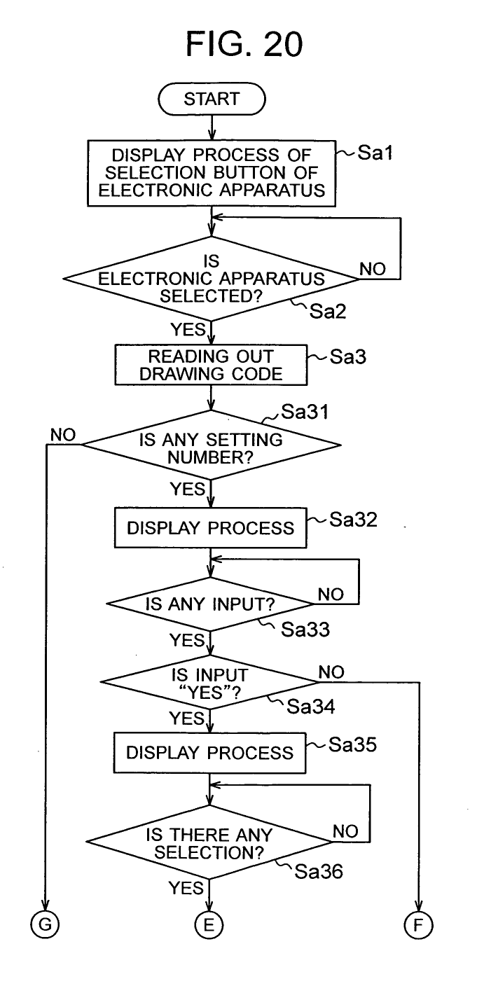

Meanwhile, in order to make a user select the setting number, it is necessary to maintain the setting number in the remote control device 2. Therefore, in this embodiment, the drawing codes and the keywords are recorded so as to correspond to each other, and the setting number allocated to the electronic apparatus 1-k are recorded so as to correspond thereto as shown in FIG. 19.

The drawing code and the setting number which are recorded in the drawing code recording unit 23 are read out by the control unit 21 of the remote control device 2 and sent to the electronic apparatus 1-k.

An operation when the remote control information is obtained from the electronic apparatus 1-k in the remote control system S will be described below. In the following, it will be explained so that th arrangement table file of the setting numbers of No. “” to No. “” are recorded in the electronic apparatus 1-k, and the information shown in FIG. 19 is already stored the drawing code recording unit 23 of the remote control unit 2.

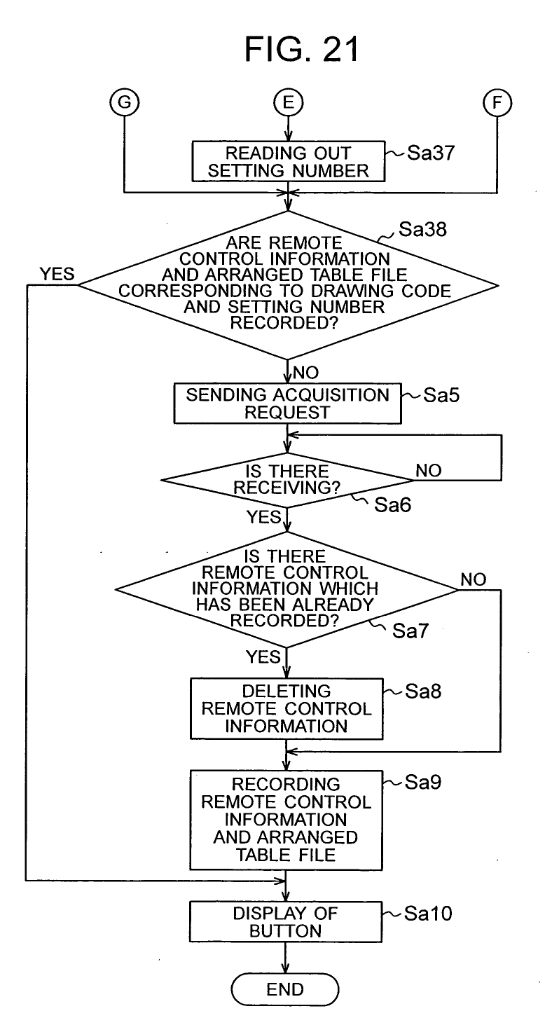

In this state, the user does a predetermined input operation on the instruction input unit 26 of the remote control device 2. Then the control unit 21 of the remote control device 2 starts processes shown in the flow charts of FIGS. 21 and 22. In the processes, the control unit 21 first does the processes similar to Steps Sa1 to Sa3 to thereby read out the drawing code corresponding to the electronic apparatus 1-k which is selected by the user out of the drawing code recording unit 23.

Next, the control unit 21 judges whether or not the setting number is recorded in correspondence with the read-out drawing code whether or not the setting number is recorded in Step Sa31. When it is judged to be “no” in this judgment, the process of Step Sa38 is conducted.

On the contrary thereto, when it is judged to be “yes” in Step Sa31, the control unit 31 conducts the display process to display for example a character string such as “There is an arrangement table file. Do you change its setting?” and two buttons of “yes” and “no” in Step Sa32. Then it is queued for an input by the user in Step Sa33. Then when the user inputs, the control unit 21 judges “” in Step Sa33, and judges whether or not the user input is a content of selecting the button of “yes” in Step Sa34. If it is judged to be “no” in this judgment, Step Sa38 is completed without processing Steps Sa35 to Sa37.

On the other hand, when it is judged to be “yes” in Step Sa34, the control unit 21 reads out the setting number which is recorded in the drawing code recording unit 23 along with the character code such as “Please select the setting number” and displays the buttons for selecting the setting number in Step Sa36. The process of the same step is repeated along “no” until the input information is conducted. When the user conducts an input operation for selecting the buttons, the control unit 21 judges to be “yes” in Step Sc36. Then, the setting number corresponding to the selected button is read out in Step Sa37.

Next, the control unit 12 judges whether or not the combination of the drawing code which is read out in Step Sa3, the remote control information corresponding to the setting number which is read out in Step Sa37, and the arrangement table file is already recorded in the remote control information recording unit 22 in Step Sa38. When the setting number is not set or the user does not request a change of the display mode, since the setting number is not read out, the control unit 21 judges only whether or not a record of the remote control information exists in Step Sa38. When it is judged to be “yes” as the result of the judgment, the control unit 21 displays the buttons on the basis of the remote control information which is already recorded or the like in Step Sa10. Then the process is completed.

On the contrary thereto, when it is judged to be “no” in Step Sa38, after the control unit 21 conducts processes similar to Steps Sa5 to Sa8 in FIG. 10, Step Sa90 is processed and the remote control information or the like which is sent from the electronic apparatus 1-k is recorded in the remote control information recording unit 22.

Meanwhile, when an acquisition request is sent in Step Sa5, the control unit 12 adds both of the drawing code which is read out in Step Sa3 and the setting number which is read out in Step Sa37 or only the drawing code to the acquisition request and sends these.

On the other hand, when the acquisition request is sent in Step Sa5, the remote control unit 123 of the electronic apparatus 1-k sends both of the remote control information and the arrangement table file or only the remote control information with respect to the acquisition request by conducting the processes shown in FIG. 12.

Meanwhile, in Step Sb1 of the processes, the remote control unit 123 extracts the setting number if the setting number is attached when the drawing code is added at the time of extracting the drawing code contained in the received acquisition request. When the setting number is extracted in Step Sa1 at the time of reading out the remote control information in Step Sa1, the arrangement table file corresponding to the setting number is read out. Then both of the remote control information which is read out in this process and occasionally both of the remote control information and the arrangement table file are sent to the remote control device 2 in Step Sb5.

As such the remote control device according to this embodiment has a structure such that the sending unit 24 for sending the generated arrangement table file is further included, and the electronic apparatus 1-k further includes the recording medium in which the sent arrangement table file is recorded and the remote control unit 123 which distributes the recorded arrangement table file upon request of the remote control device 2. According to the structure, the arrangement table file which is generated in the remote control device 2 is sent to the electronic apparatus 1-k, stored in the remote control apparatus 1-k, and sent to the remote control device 2 upon request of the remote control device 2.

Accordingly, even when a plurality of users of the remote control device 2 exist and display modes suitable for each of the users are different, it is possible to maintain the arrangement table file corresponding to the display modes modes suitable for each of the users and change the display modes by utilizing the arrangement table file later. Further, such effects are to improve user-friendliness using the remote control device 2.

Although the arrangement table file is generated in the remote control device 2 and the arrangement table file is maintained in the electronic apparatus 1-k. However, it may possible to change the remote control information itself when the arrangement is changed in the remote control device 2, and directly control the remote control information with this change added by the electronic apparatus.

Further, although a structure such that the setting numbers are allocated to each of the arrangement table files, and the arrangement table file is specified by the combinations of the setting numbers and the drawing codes is adopted, it may possible to set a plurality of the drawing codes to each of the electronic apparatuses and control the arrangement table file by the drawing codes.

The present invention is not confined to the configurations listed in the foregoing embodiments, but it is easily understood that the person skilled in the art can modify such configurations into various other modes, within the scope of the present invention described in the claims.

The entire disclosures of Japanese Patent Application No. 2004-81409 filed on Mar. 19, 2004 including the specification, claims, drawings and summary are incorporated herein by reference in its entirety.

1. A remote control device which remotely controls an electronic apparatus comprising:
a recording device which records control information that defines each of operations of processes in the electronic apparatus;
a control device which displays an operation screen on which a plurality of selection images for a selection of each of the processes that are defined by the control information are arranged;
an instruction input device which includes at least an operating element that is located on a surface of the display device and has an operation area which accepts an input operation according to the selection images selected by a user; and
a sending device which sends at least a part of the control information in correspondence with the input operation by the user on the instruction input device, wherein
the control device changes the operation screen which is to be displayed on the display device in response to the input operation by the user, and changes the operation area in the operating element in response to the change of the operation screen.

2. The remote control device according to claim 1, wherein
the recording device records the control information including at least a control code which corresponds to an executive instruction of each of the processes in the electronic apparatus, display data which correspond to the selection images, layout data which designate layout positions of the selection images in the operation screen, and
the control device displays the operation screen on the display device on the basis of the display data and the layout data.

3. The remote control device according to claim 2, wherein
the instruction input device has a second operating element which directs a change of the arrangement position of the selection image on the operation screen, and
the control device generates second arrangement data which designates the arrangement position after the change when an input operation for changing the arrangement position of the selection image is done, and displays the operation screen on the basis of the second arrangement data and the display data.

4. The remote control device according to claim 3, wherein the control device rewrites the arrangement data which are included in the control information by the generated second arrangement data, and displays the operation screen on the basis of the second arrangement data and the display data.

5. The remote control device according to claim 3, wherein the control device displays the operation screen on the basis of the display data which are included in the generated second arrangement data and the display data included in the control information without adding a change to the control information itself.

6. The remote control device according to claim 3, further comprising:
an arrangement data sending device which sends the generated second arrangement data to the electronic apparatus.

7. The remote control device according to claim 3, wherein the remote control device generates second arrangement data by which at least the arrangement position of the selection image is horizontally flipped on the operation screen when an input operation is done to change the arrangement position of the selection image, and displays the operation screen on the display device on the basis of the second arrangement data thus generated and the display data.

8. The remote control device according to claim 3, wherein the remote control device generates second arrangement data by which at least the arrangement position of the selection image is vertically flipped on the operation screen when an input operation is done to change the arrangement position of the selection image, and displays the operation screen on the display device on the basis of the second arrangement data thus generated and the display data.

9. The remote control device according to claim 3, wherein the remote control device generates second arrangement data by which at least a gap between the selection images is changed on the operation screen when an input operation is done to change the arrangement position of the selection image, and displays the operation screen on the display device on the basis of the second arrangement data thus generated and the display data.

10. The remote control device according to claim 3, wherein the remote control device generates second arrangement data by which at least the arrangement position of the selection images which is designated by a user is changed to the position designated by the user when an input operation is done to change the arrangement position of the selection image, and displays the operation screen on the display device on the basis of the second arrangement data thus generated and the display data.

11. The remote control device according to claim 2, wherein
the instruction input device has a third operating element which directs a change of the number of the arrangement of the selection images on the operation screen, and
the control device generates third arrangement data which designate the number of the arrangement of the selection images after the change when an input operation for changing the number of the arrangement of the selection images is done, and displays the operation screen on the basis of both of the third arrangement data and the display data.

12. A remote control system comprising:
an electronic apparatus; and
a remote control device which remotely controls the electronic apparatus wherein,
the remote control device includes:
a recording device which records control information that defines each of operations of processes in the electronic apparatus;
a control device which displays an operation screen on which a plurality of selection images for a selection of each of the processes that are defined by the control information are arranged;
an instruction input device which includes at least an operating element that is located on a surface of the display device and has an operation area which accepts an input operation according to the selection images selected by a user; and
a sending device which sends at least a part of the control information in correspondence with the input operation by the user on the instruction input device, wherein
the control device changes the operation screen which is to be displayed on the display device in response to the input operation by the user and simultaneously the operation area in the operating element in response to the change of the operation screen, and
the electronic apparatus has a control device which conducts a process corresponding to the control information which is sent by the sending device of the remote control device.

13. The remote control system according to claim 12, wherein the recording device of the remote control device records the control information including at least a control code which corresponds to an executive instruction of each of the processes in the electronic apparatus, display data which correspond to the selection images, arrangement data which designate arrangement positions of the selection images in the operation screen, and
the control device of the remote control device makes the operation screen display on the display device on the basis of the display data and the arrangement data.

14. The remote control system according to claim 13, wherein
the instruction input device of the remote control device has a second operating element which directs a change of the arrangement position of the selection image on the operation screen, and
the control device of the remote control device generates second arrangement data which designates the arrangement position after the change when an input operation for changing the arrangement position of the selection image is done, and displays the operation screen on the basis of the second arrangement data and the display data.

15. The remote control system according to claim 14, wherein
the remote control device further includes an arrangement data sending device which sends the second arrangement data thus generated, and
the electronic apparatus further includes:
an arrangement data recording device which records the second arrangement data thus sent;
a distribution device which distributes the second arrangement data thus recorded in response to a request from the remote control device.
